(19) United States
(12) Patent Application Publication
(10) Pub. No.: US 2014/0347745 A1
(43) Pub. Date: Nov. 27, 2014

(54) IMAGING LENS AND IMAGING APPARATUS EQUIPPED WITH THE IMAGING LENS

(71) Applicant: FUJIFILM Corporation, Tokyo (JP)

(72) Inventor: Yoshikazu SHINOHARA, Saitama-ken (JP)

(21) Appl. No.: 14/446,488

(22) Filed: Jul. 30, 2014

Related U.S. Application Data
(63) Continuation of application No. PCT/JP2013/000278, filed on Jan. 22, 2013.
(60) Provisional application No. 61/607,939, filed on Mar. 7, 2012.

(30) Foreign Application Priority Data
Jan. 30, 2012 (JP) 016812/2012

(51) Int. Cl. G02B 13/00; G02B 9/62

(52) U.S. Cl. CPC G02B 13/0045; G02B 9/62
USPC 359/713

(57) ABSTRACT

The distance along the optical axis from the surface of a first lens toward the object side to an image formation plane is 10 mm or less in an imaging lens. The imaging lens is constituted by: the first lens having a positive refractive power and a convex surface toward an object side; a second lens having a negative refractive power; a third lens having a positive refractive power; a fourth lens having a negative refractive power; a fifth lens having a positive refractive power; and a sixth lens having a surface toward an image side which is concave in the vicinity of an optical axis and convex at the peripheral portions thereof. An aperture stop is provided more toward the object side than the surface of the third lens toward the image side.

### CROSS REFERENCE TO RELATED APPLICATIONS

The present application is a Continuation of PCT International Application No. PCT/JP2013/000278, filed on Jan. 22, 2013, which claims priorities under 35 U.S.C. §119(a) to Japanese Patent Application No. 2012-016812, filed on Jan. 30, 2012 and U.S. Provisional Patent Application No. 61/607, 939, filed on Mar. 7, 2012. Each of the above application(s) is hereby expressly incorporated by reference in its entirety, into the present application.

### BACKGROUND OF THE INVENTION

1. Technical Field

The present invention is related to a fixed focus imaging lens for forming optical images of subjects onto an imaging element such as a CCD (Charge Coupled Device) and a CMOS (Complementary Metal Oxide Semiconductor). The present invention is also related to an imaging apparatus provided with the imaging lens that performs photography such as a digital still camera, a cellular telephone with a built in camera, a PDA (Personal Digital Assistant), a smart phone, and a portable gaming device.

2. Background Art

Accompanying the recent spread of personal computers in households, digital still cameras capable of inputting image data such as photographed scenes and portraits into personal computers are rapidly becoming available. In addition, many cellular telephones, smart phones, and tablet type terminals are being equipped with camera modules for inputting images. Imaging elements such as CCD's and CMOS's are employed in these devices having photography functions. Recently, miniaturization of these imaging elements is advancing, and there is demand for miniaturization of the entirety of the photography devices as well as imaging lenses to be mounted thereon. At the same time, the number of pixels in imaging elements is increasing, and there is demand for high resolution and high performance of imaging lenses. Performance corresponding to 5 megapixels or greater, and more preferably 8 megapixels or greater, is desired.

In response to such demands, imaging lenses having a five lens configuration or a six lens configuration, which are comparatively large numbers of lenses, may be considered in order to shorten the total length of the imagine lens and to achieve high resolution (refer to Japanese Unexamined Patent Publication Nos. 2010-262269, 2010-262270, and 2002-365546).

### DISCLOSURE OF THE INVENTION

Meanwhile, the pixel sizes of imaging elements are becoming smaller accompanying the increase in the numbers of pixels therein, with respect to imaging lenses having comparatively short total lengths, which are employed particularly in portable terminals, smart phones, and tablet terminals. For this reason, there is demand for an imaging lens to be realized, which has a small F number and is compatible with a compact imaging element, while also having high performance.

It is necessary for the imaging lenses having the five lens configuration disclosed in Japanese Unexamined Patent Publication Nos. 2010-262269 and 2010-262270 to correct spherical aberration or longitudinal chromatic aberration more favorably. In addition, it is desired for the total length to be shorter and for the F number to be lower in the imaging lens having the six lens configuration disclosed in Japanese Unexamined Patent Publication No. 2002-365546.

The present invention has been developed in view of the foregoing points. The object of the present invention is to provide an imaging lens with a small F number that can realize high imaging performance from a central angle of view through peripheral angles of view while having a short total length. It is another object of the present invention to provide an imaging apparatus equipped with the lens, which is capable of obtaining high resolution photographed images.

An imaging lens of the present invention substantially consists of six lenses, including:

a first lens having a positive refractive power and a convex surface toward an object side;

a second lens having a negative refractive power;

a third lens having a positive refractive power;

a fourth lens having a negative refractive power;

a fifth lens having a positive refractive power; and

a sixth lens having a surface toward an image side which is concave in the vicinity of an optical axis and convex at the peripheral portions thereof, provided in this order from the object side;

an aperture stop being provided more toward the object side than the surface of the third lens toward the image side; and

the distance along the optical axis from the surface of the first lens toward the object side to an image formation plane being 10 mm or less.

The imaging lens of the present invention optimizes the configuration of each lens element within a lens configuration having six lenses as a whole, and the shapes of the first lens and the sixth lens are favorably configured in particular. Therefore, a lens system having a short total length, a small F number, and high imaging performance can be realized.

Note that an air converted value is employed for the portion corresponding to the back focus in the distance along the optical axis from the surface of the first lens toward the object side to the image formation plane (total length of the lens system). For example, in the case that a member without any refractive power, such as a filter or a cover glass, is provided between the lens most toward the image side and the image formation plane, the thickness of the member is converted into air to calculate the distance.

Note that in the imaging lens of the present invention, the expression “substantially consists of six lenses” means that the imaging lens of the present invention may also include lenses that practically have no power, optical elements other than lenses such as an aperture stop and a cover glass, and mechanical components such as lens flanges, a lens barrel, an imaging element, a camera shake correcting mechanism, etc., in addition to the six lenses.

The optical performance of the imaging lens of the present invention can be further improved by adopting the following favorable configurations.

In the imaging lens of the present invention, it is preferable for the sixth lens to have a negative refractive power.

In the imaging lens of the present invention, it is preferable for the second lens to have a concave surface toward the image side.

In the imaging lens of the present invention, it is preferable for the fifth lens to have a convex surface toward the image side.

In the imaging lens of the present invention, it is preferable for the aperture stop to be provided more toward the object side than the surface of the first lens toward the image side.

It is preferable for the imaging lens of the present invention to satisfy one of Conditional Formulae (1) through (6) and (8) through (9-1) below. Note that a preferred aspect of the imaging lens of the present invention may satisfy any one of Conditional Formulae (1) through (6) and (8) through (9-1), or may satisfy arbitrary combinations of Conditional Formulae (1) through (6) and (8) through (9-1).

vd2<35 (1)

vd2<30 (1-1)

vd4<35 (2)

vd4<30 (2-1)

1/f2<1/f4 (3)

1/f6<1/f4 (4)

1/f3<1/f1 (5)

1/f1<1/f5 (6)

−1.0<(1−Nd2)/R5<0 (8)

−0.3<(1−Nd2)/R5<−0.05 (8-1)

0<(1−Nd5)/R11<1.0 (9)

0.05<(1−Nd5)/R11<0.4 (9-1)

wherein vd2 is the Abbe's number of the second lens with respect to the d line, vd4 is the Abbe's number of the fourth lens with respect to the d line, f1 is the focal length of the first lens, f2 is the focal length of the second lens, f3 is the focal length of the third lens, f4 is the focal length of the fourth lens, f5 is the focal length of the fifth lens, f6 is the focal length of the sixth lens, Nd2 is the refractive index of the second lens with respect to the d line, Nd5 is the refractive index of the fifth lens with respect to the d line, R5 is the radius of curvature of the surface of the second lens toward the image side, and R11 is the radius of curvature of the surface of the fifth lens toward the image side.

An imaging apparatus of the present invention is equipped with the imaging lens of the present invention.

The imaging apparatus of the present invention outputs image signals corresponding to high resolution optical images formed by the imaging lens of the present invention. Therefore, the imaging apparatus of the present invention is capable of obtaining high resolution image signals.

The imaging lens of the present invention optimizes the configuration of each lens element within a lens configuration having six lenses as a whole, and the shapes of the first lens and the sixth lens are favorably configured in particular. Therefore, a lens system having a short total length, a small F number, and high imaging performance from a central angle of view to peripheral angles of view can be realized.

In addition, the imaging apparatus of the present invention outputs image signals corresponding to optical images formed by the imaging lens of the present invention, which has high imaging performance. Therefore, the imaging apparatus of the present invention is capable of obtaining high resolution photographed images.

### BRIEF DESCRIPTION OF THE DRAWINGS

FIG. 1 is a sectional diagram that illustrates a first example of the configuration of an imaging lens according to an embodiment of the present invention, and corresponds to a lens of Example 1.

FIG. 2 is a sectional diagram that illustrates a second example of the configuration of an imaging lens according to an embodiment of the present invention, and corresponds to a lens of Example 2.

FIG. 3 is a sectional diagram that illustrates a third example of the configuration of an imaging lens according to an embodiment of the present invention, and corresponds to a lens of Example 3.

FIG. 4 is a sectional diagram that illustrates a fourth example of the configuration of an imaging lens according to an embodiment of the present invention, and corresponds to a lens of Example 4.

FIG. 5 is a sectional diagram that illustrates a fifth example of the configuration of an imaging lens according to an embodiment of the present invention, and corresponds to a lens of Example 5.

FIG. 6 is a sectional diagram that illustrates a sixth example of the configuration of an imaging lens according to an embodiment of the present invention, and corresponds to a lens of Example 6.

FIG. 7 is a sectional diagram that illustrates a seventh example of the configuration of an imaging lens according to an embodiment of the present invention, and corresponds to a lens of Example 7.

FIG. 8 is a sectional diagram that illustrates an eighth example of the configuration of an imaging lens according to an embodiment of the present invention, and corresponds to a lens of Example 8.

FIG. 9 is a sectional diagram that illustrates a ninth example of the configuration of an imaging lens according to an embodiment of the present invention, and corresponds to a lens of Example 9.

FIG. 10 is a diagram that illustrates the paths of light rays that pass through the imaging lens of FIG. 1.

FIG. 11 is a collection of diagrams that illustrate aberrations of the imaging lens of Example 1, wherein A illustrates spherical aberration, B illustrates sine conditions, C illustrates astigmatic aberration (field curvature), D illustrates distortion, and E illustrates lateral chromatic aberration.

FIG. 12 is a collection of diagrams that illustrate aberrations of the imaging lens of Example 2, wherein A illustrates spherical aberration, B illustrates sine conditions, C illustrates astigmatic aberration (field curvature), D illustrates distortion, and E illustrates lateral chromatic aberration.

FIG. 13 is a collection of diagrams that illustrate aberrations of the imaging lens of Example 3, wherein A illustrates spherical aberration, B illustrates sine conditions, C illustrates astigmatic aberration (field curvature), D illustrates distortion, and E illustrates lateral chromatic aberration.

FIG. 14 is a collection of diagrams that illustrate aberrations of the imaging lens of Example 4, wherein A illustrates spherical aberration, B illustrates sine conditions, C illustrates astigmatic aberration (field curvature), D illustrates distortion, and E illustrates lateral chromatic aberration.

FIG. 15 is a collection of diagrams that illustrate aberrations of the imaging lens of Example 5, wherein A illustrates spherical aberration, B illustrates sine conditions, C illustrates astigmatic aberration (field curvature), D illustrates distortion, and E illustrates lateral chromatic aberration.

FIG. 16 is a collection of diagrams that illustrate aberrations of the imaging lens of Example 6, wherein A illustrates spherical aberration, B illustrates sine conditions, C illustrates astigmatic aberration (field curvature), D illustrates distortion, and E illustrates lateral chromatic aberration.

FIG. 17 is a collection of diagrams that illustrate aberrations of the imaging lens of Example 7, wherein A illustrates spherical aberration, B illustrates sine conditions, C illustrates astigmatic aberration (field curvature), D illustrates distortion, and E illustrates lateral chromatic aberration.

FIG. 18 is a collection of diagrams that illustrate aberrations of the imaging lens of Example 8, wherein A illustrates spherical aberration, B illustrates sine conditions, C illustrates astigmatic aberration (field curvature), D illustrates distortion, and E illustrates lateral chromatic aberration.

FIG. 19 is a collection of diagrams that illustrate aberrations of the imaging lens of Example 9, wherein A illustrates spherical aberration, B illustrates sine conditions, C illustrates astigmatic aberration (field curvature), D illustrates distortion, and E illustrates lateral chromatic aberration.

FIG. 20 is a diagram that illustrates a cellular telephone as an imaging apparatus equipped with the imaging lens of the present invention.

FIG. 21 is a diagram that illustrates a smart phone as an imaging apparatus equipped with the imaging lens of the present invention.

### BEST MODE FOR CARRYING OUT THE INVENTION

Hereinafter, embodiments of the present invention will be described in detail with reference to the attached drawings.

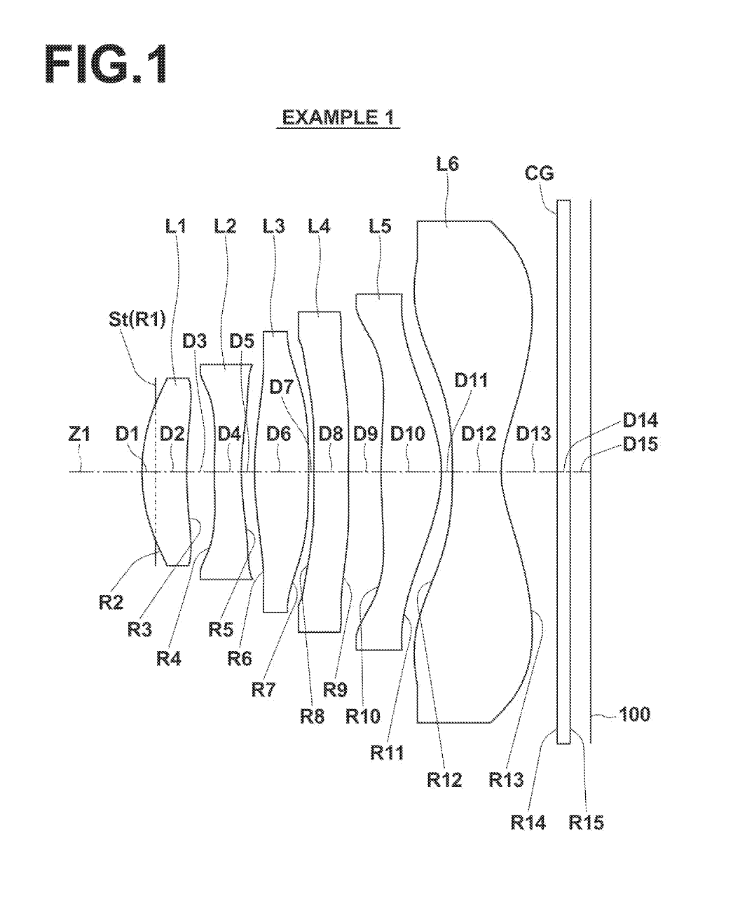

FIG. 1 illustrates a first example of the configuration of an imaging lens according to an embodiment of the present invention.

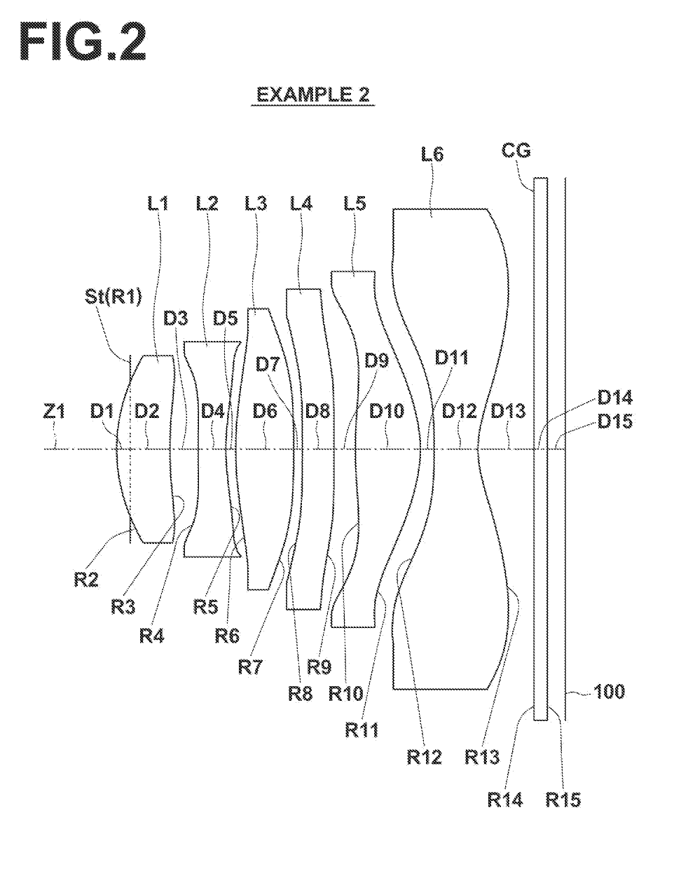

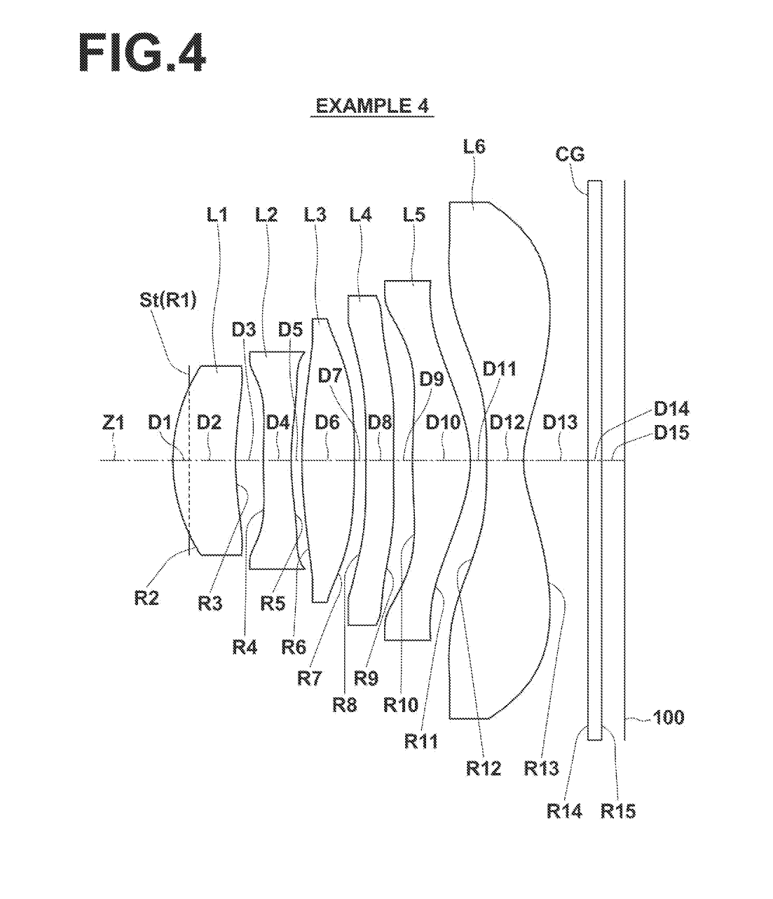

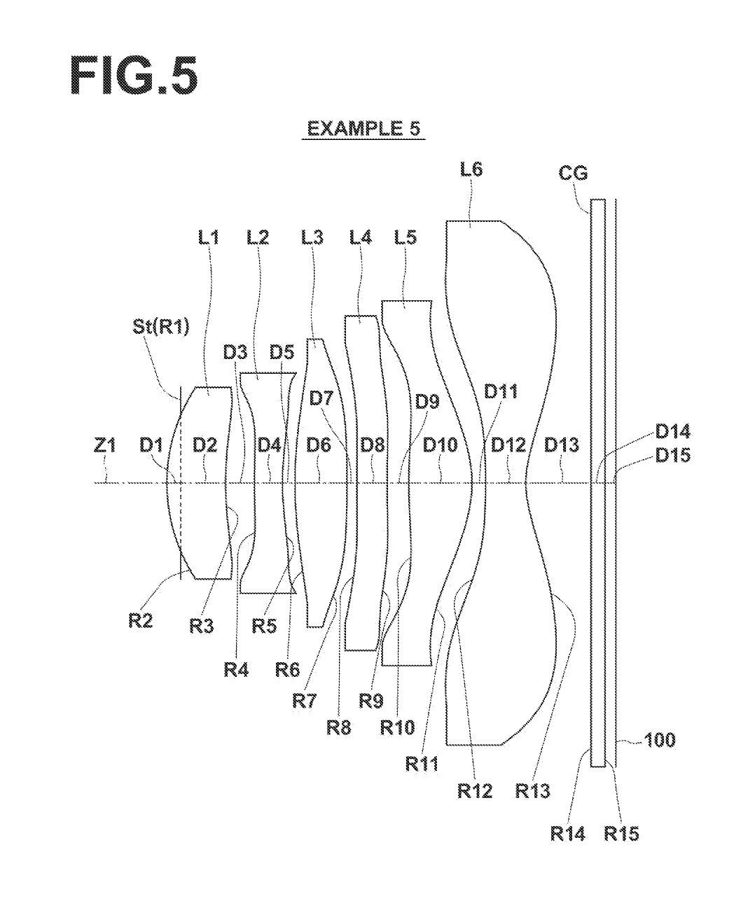

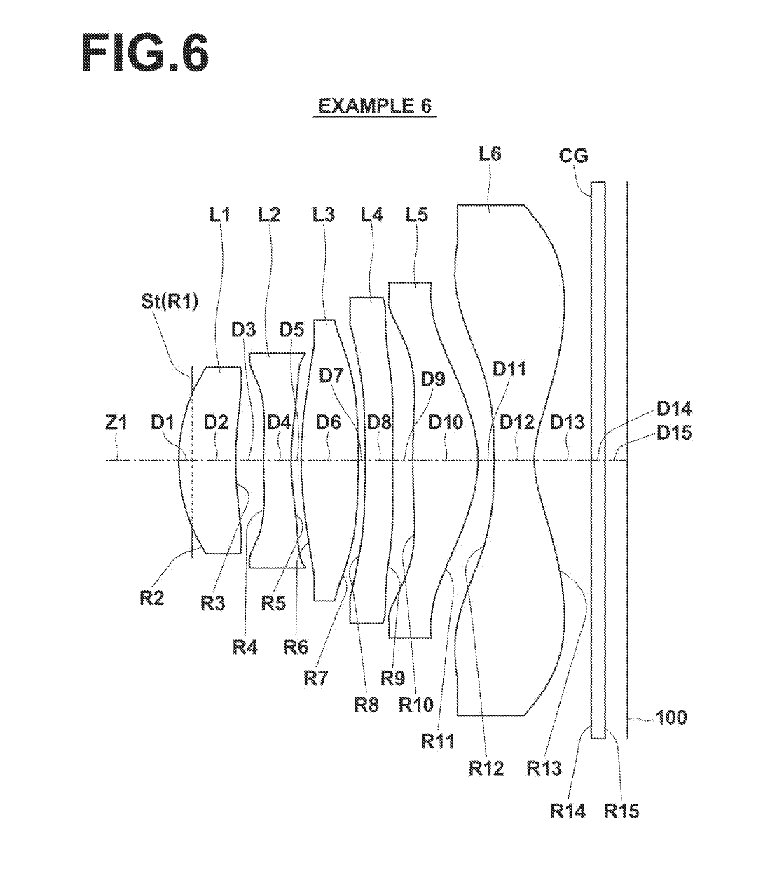

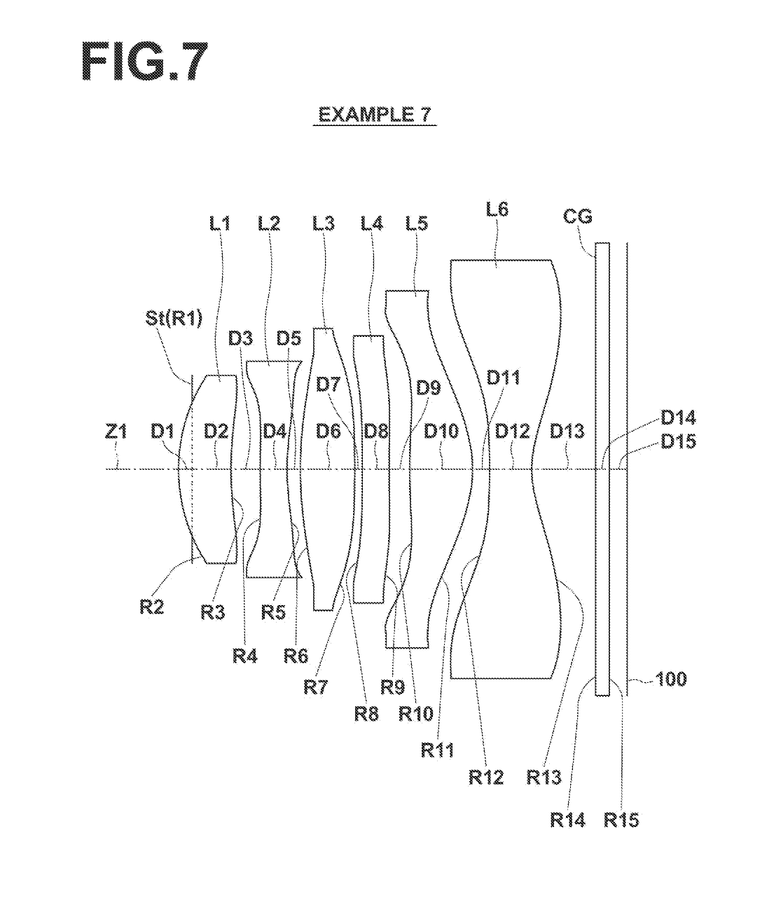

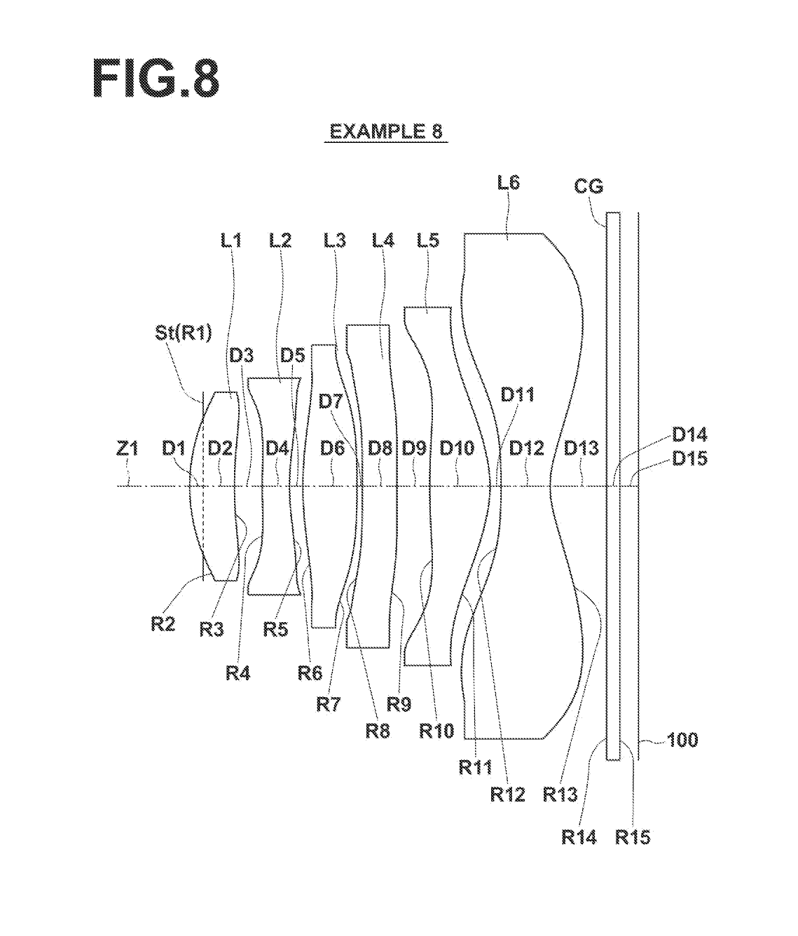

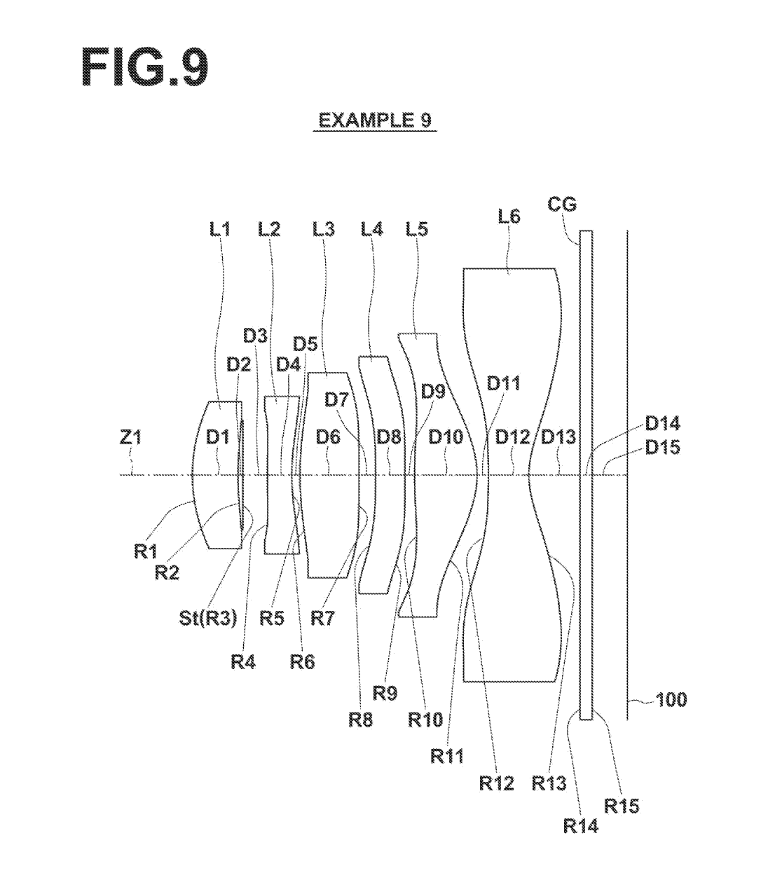

This example corresponds to the lens configuration of Numerical Example 1 (Tables 1 and 10), to be described later. Similarly, FIG. 2 through FIG. 9 are sectional diagrams that illustrate second through ninth examples of lens configurations that correspond to Numerical Examples 2 through 9 (Tables 2 through 9 and Tables 11 through 18). In FIG. 1 through FIG. 9, the symbol Ri represents the radii of curvature of ith surfaces, i being lens surface numbers that sequentially increase from the object side to the image side (imaging side), with the surface of a lens element most toward the object side designated as first. The symbol Di represents the distances between an ith surface and an i+1st surface along an optical axis Z1. Note that the basic configurations of the examples are the same, and therefore a description will be given of the imaging lens of FIG. 1 as a base, and the examples of FIG. 2 through FIG. 9 will also be described as necessary.

The imaging lens L of the embodiment of the present invention is favorably employed in various imaging devices that employ imaging elements such as a CCD and a CMOS. The imaging lens L of the embodiment of the present invention is particularly favorable for use in comparatively compact portable terminal devices, such as a digital still camera, a cellular telephone with a built in camera, a smart phone, a tablet type terminal, and a PDA. The imaging lens L is equipped with a first lens L1, a second lens L2, a third lens L3, a fourth lens L4, a fifth lens L5, and a sixth lens L6 along the optical axis Z1, in this order from the object side.

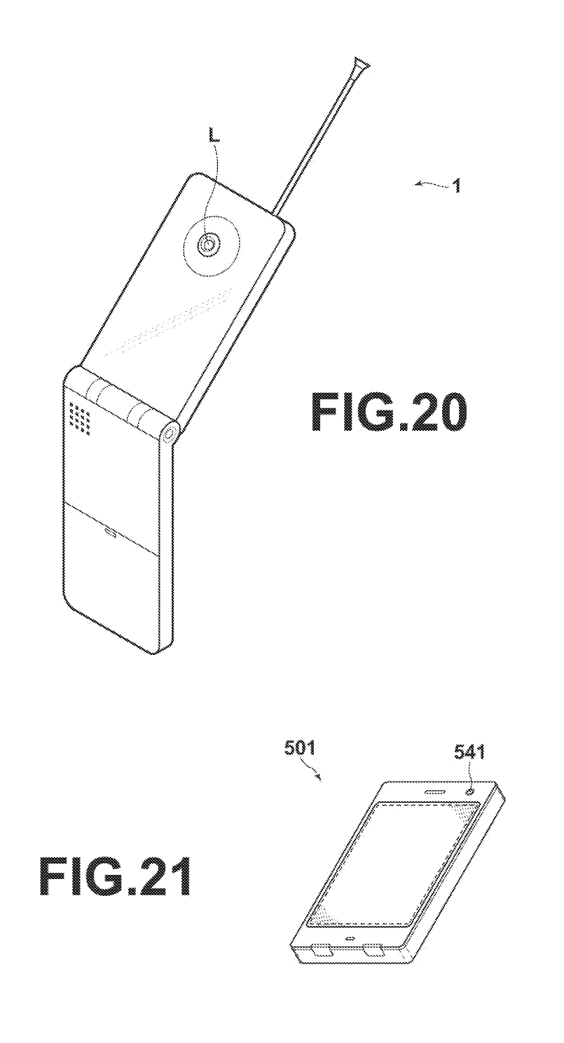

FIG. 20 schematically illustrates a cellular telephone as an imaging apparatus 1 according to an embodiment of the present invention. The imaging apparatus 1 of the embodiment of the present invention is equipped with the imaging lens L according to the embodiment of the present invention and an imaging element 100 (refer to FIG. 1) such as a CCD that outputs image signals corresponding to optical images formed by the imaging lens L. The imaging element 100 is provided at an image formation plane (imaging surface) of the imaging lens L.

FIG. 21 schematically illustrates a smart phone as an imaging apparatus 501 according to an embodiment of the present invention. The imaging apparatus 501 of the embodiment of the present invention is equipped with a camera section 541 having the imaging lens L according to the embodiment of the present invention and an imaging element 100 (refer to FIG. 1) such as a CCD that outputs image signals corresponding to optical images formed by the imaging lens L. The imaging element 100 is provided at an image formation plane (imaging surface) of the imaging lens L.

Various optical members CG may be provided between the sixth lens L6 and the imaging element 100, depending on the configuration of the camera to which the lens is applied. A planar optical member such as a cover glass for protecting the imaging surface and an infrared cutoff filter may be provided, for example. In this case, a planar cover glass having a coating having a filtering effect such as an infrared cutoff filter coating or an ND filter coating may be utilized as the optical member CG.

Alternatively, the optical member CG may be omitted, and a coating may be administered on the sixth lens L6 to obtain the same effect as that of the optical member CG. In this case, the number of parts can be reduced, and the total length can be shortened.

The imaging lens is also provided with an aperture stop St provided more toward the object side than the surface of the third lens L3 toward the image side. By providing the aperture stop St more toward the object side than the surface of the third lens L3 toward the image side, increases in the incident angles of light rays that pass through the imaging lens L and enter the imaging surface (imaging element) can be favorably suppressed, particularly at peripheral portions of an imaging region.

Further, it is preferable for the aperture stop St to be provided more toward the object side than the surface of the first lens L1 toward the image side. By providing the aperture stop St more toward the object side than the surface of the first lens L1 toward the image side, increases in the incident angles of light rays that pass through the imaging lens L and enter the imaging surface (imaging element) can be more favorably suppressed, and higher optical performance can be realized.

In the imaging lens L, the first lens L1 has a positive refractive power in the vicinity of the optical axis. The first lens L1 has a convex surface toward the object side in the vicinity of the optical axis. By the first lens L1 having a convex surface toward the object side, the total length of the lens system can be shortened in a final form.

The second lens L2 has a negative refractive power in the vicinity of the optical axis. In addition, it is preferable for the second lens L2 to have a concave surface toward the image side in the vicinity of the optical axis. In this case, balance with the negative power of the surface toward the object side can be more favorably maintained than in a case in which the second lens has a convex surface toward the image side. Therefore, suppressing generation of high order spherical aberration is facilitated. Further, it is more preferable for the second lens L2 to be of a meniscus shape having a concave surface toward the image side in the vicinity of the optical axis. In the case that the second lens L2 is of a meniscus shape having a concave surface toward the image side in the vicinity of the optical axis, the total length of the lens system can be more favorably realized.

The third lens L3 has a positive refractive power in the vicinity of the optical axis. In addition, it is preferable for the third lens L3 to have a convex surface toward the object side in the vicinity of the optical axis, as shown in each of the examples.

The fourth lens L4 has a negative refractive power in the vicinity of the optical axis.

The fifth lens L5 has a positive refractive power in the vicinity of the optical axis. In addition, it is preferable for the fifth lens L5 to have a convex surface toward the image side in the vicinity of the optical axis. Astigmatism can be favorably corrected in the case that the fifth lens L5 has a convex surface toward the image side. Further, shortening of the total length of the lens system can be more favorably realized in the case that fifth lens L5 is of a biconvex shape.

In the imaging lens L, the surface of the sixth lens L6 toward the image side is concave toward the image side in the vicinity of the optical axis, and convex at the peripheral portions thereof, as will be described later. By setting the shape of the fifth lens L5 appropriately to correspond to the shape of the sixth lens L6, increases in field curvature and/or distortion that will occur due to shortening of the total length of the lens system can be more effectively suppressed, and field curvature can be favorably corrected in particular. It is desirable for the portion of the sixth lens L6 corresponding to the convex portion of the fifth lens L5 having power in the direction of the optical axis to be concave, and for the portion of the sixth lens L6 corresponding to a concave portion of the fifth lens L5 having power in the direction of the optical axis to be convex.

As described above, the surface of the sixth lens L6 toward the image side is concave toward the image side in the vicinity of the optical axis, and convex at the peripheral portions thereof. Therefore, the lens system can be designed to have a short total length, while increases in field curvature and/or distortion caused by shortening the total length can be suppressed, and various aberrations can be favorably corrected. Further, the above shape of the surface of the sixth lens L6 toward the image side can suppress increases in the incident angles of light rays that pass through the optical system at peripheral angles of view into the imaging surface (imaging element), particularly at the peripheral portions of the imaging region. Note that here, the peripheral portions of the imaging region refer to portions toward the exterior of approximately 50% to 70% of the effective diameter.

In addition, it is preferable for the sixth lens L6 to have a negative refractive power. If the first lens L1 through the fifth lens L5 are considered to be a single positive optical system and in the case that the sixth lens L6 has a negative refractive power, the imaging lens can be of a telephoto type configuration as a whole, and the total length thereof can be favorably shortened.

The imaging lens L has the first lens L1 with a positive refractive power, the second lens L2 with a negative refractive power, the third lens L3 with a positive refractive power, the fourth lens L4 with a negative refractive power, and the fifth lens L5 with a positive refractive power. That is, positive lenses and negative lenses are alternately arranged. For this reason, spherical aberration which is generated in each positive lens can be favorably corrected by the negative lens adjacent thereto toward the image side. Therefore, the generation of high order spherical aberration car, be suppressed to a higher degree than in conventional lenses, and spherical aberration can be favorably corrected.

It is preferable for at least one of the surfaces of each of the first lens L1 through the sixth lens L6 of the imaging L to be an aspherical surface, in order to improve performance.

In addition, it is preferable for the lenses L1 through L6 that constitute the imaging lens L to be single lenses, not cemented lenses. If such a configuration is adopted, the number of aspherical surfaces is greater than that in a case in which any of the lenses L1 through L6 is a cemented lens. Therefore, the degree of freedom in the design of each lens is increased, and the lens can be favorably designed to have a shorter total length.

Next, the operation and effects of conditional formulae related to the imaging lens L will be described in greater detail.

First, it is preferable for the Abbe's number vd2 of the second lens L2 with respect to the d line to satisfy Conditional Formula (1) below.

vd2<35 (1)

Conditional Formula (1) defines a preferable range of numerical values for the Abbe's number vd2 of the second lens L2 with respect to the d line. By satisfying Conditional Formula (1), the second lens L2 may be produced from a high dispersion material, which is advantageous from the viewpoint of correcting longitudinal chromatic aberration. In view of the above, it is more preferable for Conditional Formula (1-1) below to be satisfied.

vd2<30 (1-1)

It is preferable for the Abbe's number vd4 of the fourth lens L4 with respect to the d line to satisfy Conditional Formula (2) below.

vd4<35 (2)

Conditional Formula (2) defines a preferable range of numerical values for the Abbe's number vd4 of the fourth lens L4 with respect to the d line. By satisfying Conditional Formula (2), the fourth lens L4 may be produced from a high dispersion material, which is advantageous from the viewpoint of correcting high order longitudinal chromatic aberration. In addition, lateral chromatic aberration, which is likely to be generated by the fifth lens L5 and/or the sixth lens L6, can be favorably corrected. In view of the above, it is more preferable for Conditional Formula (2-1) below to be satisfied.

vd4<30 (2-1)

In addition, the focal length f2 of the second lens L2 and the focal length f4 of the fourth lens L4 satisfy Conditional Formula (3) below.

1/f2<1/f4 (3)

Conditional Formula (3) defines a preferable range of numerical values for the focal length f2 of the second lens L2 and the focal length f4 of the fourth lens L4. In the case that Conditional Formula (3) is not satisfied, the negative refractive power of the fourth lens L4 will become excessively strong with respect to the second lens L2 in the entire lens system, and it will become difficult to correct longitudinal chromatic aberration and lateral chromatic aberration with favorable balance. Particularly, correction of longitudinal chromatic aberration will become difficult. For this reason, various aberrations can be favorably corrected by satisfying the range defined in Conditional Formula (3).

In addition, the focal length f6 of the sixth lens L6 and the focal length f4 of the fourth lens L4 satisfy Conditional Formula (4) below.

1/f6<1/f4 (4)

Conditional Formula (4) defines a preferable range of numerical values for the focal length f6 of the sixth lens L6 and the focal length f4 of the fourth lens L4. In the case that Conditional Formula (4) is not satisfied, the negative refractive power of the sixth lens L6 will become excessively weak with respect to the negative refractive power of the fourth lens L4 in the entire lens system, and field curvature will increase, resulting in difficulties in obtaining favorable imaging performance. For this reason, various aberrations can be favorably corrected by satisfying the range defined in Conditional Formula (4).

Further, it is preferable for the focal length f6 of the sixth lens L6, the focal length f2 of the second lens L2, and the focal length f4 of the fourth lens L4 satisfy Conditional Formula (4-1) below. In the case that Conditional Formula (4-1) is satisfied, the negative refractive powers are strong in the order from the fourth lens L4, the second lens L2, and the sixth lens L6 in the entire lens system. Therefore, the negative refractive power of the sixth lens L6 will be an appropriate strength with respect to the negative refractive powers of the second lens L2 and the fourth lens L4, enabling longitudinal chromatic aberration to be corrected more favorably.

1/f6<1/f2<1/f4 (4-1)

In addition, the focal length f3 of the third lens L3 and the focal length f1 of the first lens L1 satisfy Conditional Formula (5) below.

1/f3<1/f1 (5)

Conditional Formula (5) defines a preferable range of numerical values for the focal length f3 of the third lens L3 and the focal length f1 of the first lens L1. In the case that Conditional Formula (5) is not satisfied, the positive refractive power of the third lens L3 will become excessively strong with respect to the positive refractive power of the first lens L1, and shortening of the total length of the lens system will become difficult. For this reason, the total length of the lens system can be favorably shortened by satisfying the range defined in Conditional Formula (5).

In addition, the focal length f1 of the first lens L1 and the focal length f5 of the fifth lens L5 satisfy Conditional Formula (6) below.

1/f1<1/f5 (6)

Conditional Formula (6) defines a preferable range of numerical values for the focal length f5 of the fifth lens L5 with respect to the focal length f1 of the first lens L1. In the case that Conditional Formula (6) is not satisfied, filed curvature will increase, although such a configuration is advantageous from the viewpoint of shortening the total length of the lens system. For this reason, field curvature can be favorably corrected while shortening the total length of the lens system, by satisfying the range defined in Conditional Formula (6).

In addition, it is preferable for the configurations of the first through sixth lenses of the imaging lens L to be set such that the incident angle α of a chief ray of light at the maximum angle of view with respect to the optical axis satisfies Conditional Formula (7) below.

α<45 (7)

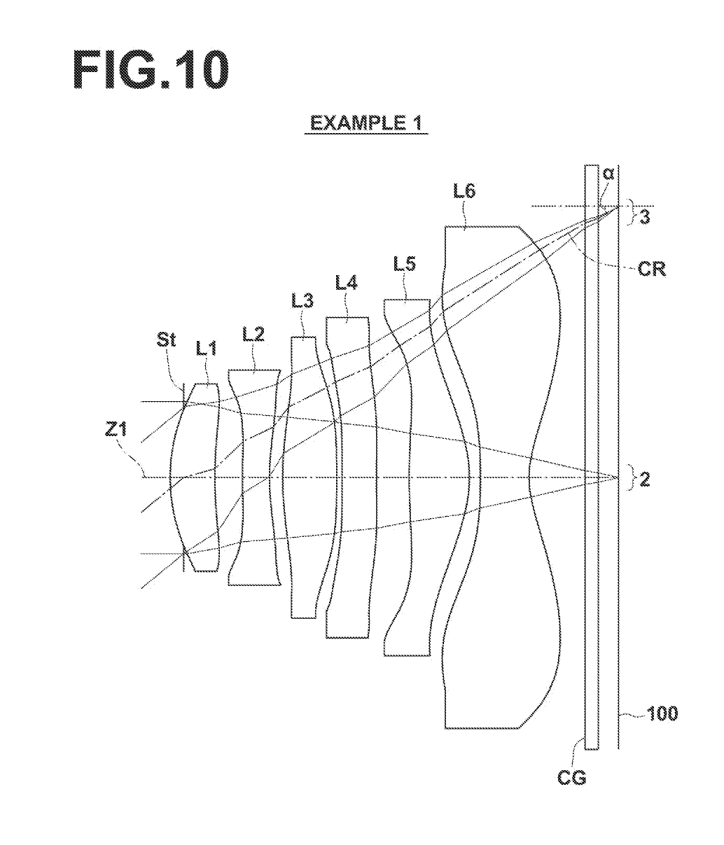

Conditional Formula (7) defines a preferable range of numerical values for the incident angle α (CRA: Chief Ray Angle) of a chief ray of light at the maximum angle of view that enters the image formation plane. FIG. 10 is a cross sectional diagram of lenses of the imaging lens L of FIG. 1 that illustrates the paths of light rays. FIG. 10 illustrates the paths of an axial light beam 2, a maximum angle of view light beam 3 from an object at a distance of infinity, and the incident angle α of a chief ray of light CR of the maximum angle of view light beam 3 with respect to the image formation plane. In the case that the configurations of the first through sixth lenses of the imaging lens L are set such that Conditional Formula (7) is satisfied, the incident angle α is an appropriate value. Therefore, photographed images having high resolution from a central angle of view to peripheral angles of view can be obtained even by an imaging apparatus equipped with a wide angle lens having a full angle of view 2ω exceeding 65 degrees, such as that illustrated in FIG. 1. Note that in the lens disclosed in Japanese Unexamined Patent Publication No. 2002-365546, the incident angle α of a chief ray of light at the maximum angle of view with respect to the image formation plane is extremely large. In an imaging apparatus having an imaging element provided at an image formation plane, the incident angle α of a chief ray of light at the maximum angle of view with respect to the image formation plane is the same as the incident angle of the ray of light with respect to the imaging element. Therefore, if an imaging element is placed at the image formation plane of the lens disclosed in Japanese Unexamined Patent Publication No. 2002-365546, the incident angle with respect to the imaging element will be excessively large, and sufficiently high resolution performance cannot be obtained, particularly at the peripheral portions of an imaging region. In view of the above, it is more preferable for Conditional Formula (7-1) below to be satisfied.

α<40 (7-1)

In addition, it is preferable for the second lens L2 to have a concave surface toward the image side in the vicinity of the optical axis as described above. In this case, it is further desirable for Conditional Formula (8) below to be satisfied.

−1.0<(1−Nd2)/R5<0 (8)

Conditional Formula (8) defines a preferable range of numerical values for the refractive index Nd2 of the second lens L2 with respect to the d line and the radius of curvature R5 of the surface of the second lens toward the image side. In the case that the second lens L2 has a concave surface toward the image side in the vicinity of the optical axis, balance can be more favorably maintained with the negative power of the surface of the second lens L2 toward the object side if Conditional Formula (8) is satisfied. As a result, the generation of high order spherical aberration can be favorably suppressed. In view of the above, it is more preferable for Conditional Formula (8-1) below to be satisfied.

−0.3<(1−Nd2)/S5<−0.05 (8-1)

In addition, it is preferable for the fifth lens L5 to have a convex surface toward the image side in the vicinity of the optical axis as described above. In this case, it is further desirable for Conditional Formula (9) below to be satisfied.

0<(1−Nd5)/R11<1.0 (9)

Conditional Formula (9) defines a preferable range of numerical values for the refractive index Nd5 of the fifth lens L5 with respect to the d line and the radius of curvature R11 of the surface of the fifth lens toward the image side. In the case that the fifth lens L5 has a convex surface toward the image side in the vicinity of the optical axis, astigmatism can be more favorably corrected if Conditional Formula (9) is satisfied. In view of the above, it is more preferable for Conditional Formula (9-1) below to be satisfied.

0.05<(1−Nd5)/R11<0.4 (9-1)

As described above, the imaging lens L according to the embodiment of the present invention optimizes the configuration of each lens element within a lens configuration having six lenses as a whole, and the shapes of the first lens and the sixth lens are favorably configured in particular. Therefore, a lens system having a short total length, a small F number, and high imaging performance can be realized.

In addition, even higher imaging performance can be realized, by appropriately satisfying preferable conditions. In addition, the imaging apparatuses according to the embodiments output image signals corresponding to optical images which are formed by the high performance imaging lens L of the present embodiment. Therefore, photographed images having high resolution from a central angle of view to peripheral angles of view can be obtained.

Next, specific examples of numerical values of the imaging lens of the present invention will be described. A plurality of examples of numerical values will be summarized and explained below.

Table 1 and Table 10 below show specific lens data corresponding to the configuration of the imaging lens illustrated in FIG. 1. Particularly, Table 1 shows basic lens data of the imaging lens, and Table 10 shows data related to aspherical surfaces. In the lens data of Table 1, ith lens surface numbers that sequentially increase from the object side to the image side, with the lens surface at the most object side designated as first (the aperture stop St being number 1), are shown in the surface number column Si for the imaging lens of Example 1. The radii of curvature (mm) of ith surfaces from the object side corresponding to the symbols Ri illustrated in FIG. 1 are shown in the radius of curvature column Ri. Similarly, the distances (mm) between an ith surface and an i+1st surface from the object side along the optical axis are shown in the distance column Di. The refractive indices of jth optical elements from the object side with respect to the d line (wavelength: 587.56 nm) are shown in the column Ndj. The Abbe's numbers of the jth optical elements with respect to the d line are shown in the column vdj. Note that the values of the focal length f (mm) of the entire system, the back focus Bf (mm), the F number Fno., the full angle of view 2ω (°), the incident angle α (°) of a chief ray at a maximum angle of view with respect to the image formation plane, and the total length TL (mm) of the lens system are shown as items of data in Table 1. Note that the back focus Bf is represented as an air converted value, and an air converted value is employed as the portion of the total length TL of the lens system corresponding to the back focus Bf.

In the imaging lens of Example 1, both of the surfaces of the first lens L1 through the sixth lens L6 are all aspherical in shape. In the basic lens data of Table 1, numerical values of radii of curvature in the vicinity of the optical axis (paraxial radii of curvature) are shown as the radii of curvature of the aspherical surfaces.

Table 10 shows aspherical surface data of the imaging lens of Example 1. In the numerical values shown as the aspherical surface data, the symbol “E” indicates that the numerical value following thereafter is a “power index” having 10 as a base, and that the numerical value represented by the index function having 10 as a base is to be multiplied by the numerical value in front of “E”. For example, “1.0E-02” indicates that the numerical value is “1.0·10⁻²”.

The values of coefficients Ai and K represented by the aspherical surface shape formula (A) below are shown as the aspherical surface data. In greater detail, Z is the length (mm) of a normal line that extends from a point on the aspherical surface having a height h to a plane (a plane perpendicular to the optical axis) that contacts the peak of the aspherical surface.

Z=C·h²/{1+(1−K·C²·h²)^{1/2}}+ΣAi·hⁱ (A)

wherein: Z is the depth of the aspherical surface (mm), h is the distance from the optical axis to the surface of the lens (height) (ran), C is the paraxial curvature=1/R (R is the paraxial radius of curvature), Ai is an ith ordinal aspherical surface coefficient (i is an integer 3 or greater), and K is an aspherical surface coefficient.

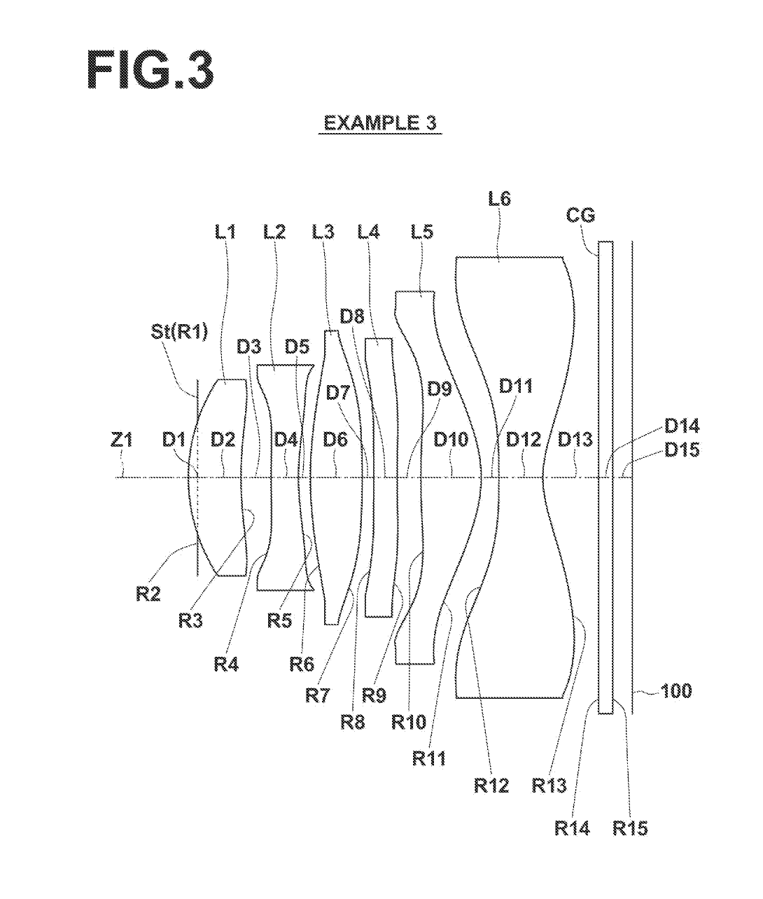

Specific lens data corresponding to the configuration of the imaging lens illustrated in FIG. 2 are shown in Table 2 and Table 11 as Example 2. Similarly, specific lens data corresponding to the configurations of the imaging lenses illustrated in FIG. 3 through FIG. 9 are shown in Tables 3 through 9 and Tables 12 through 18 as Example 3 through Example 9. In the imaging lenses of Examples 1 through 9, both of the surfaces of the first lens L1 through the sixth lens L6 are all aspherical surfaces.

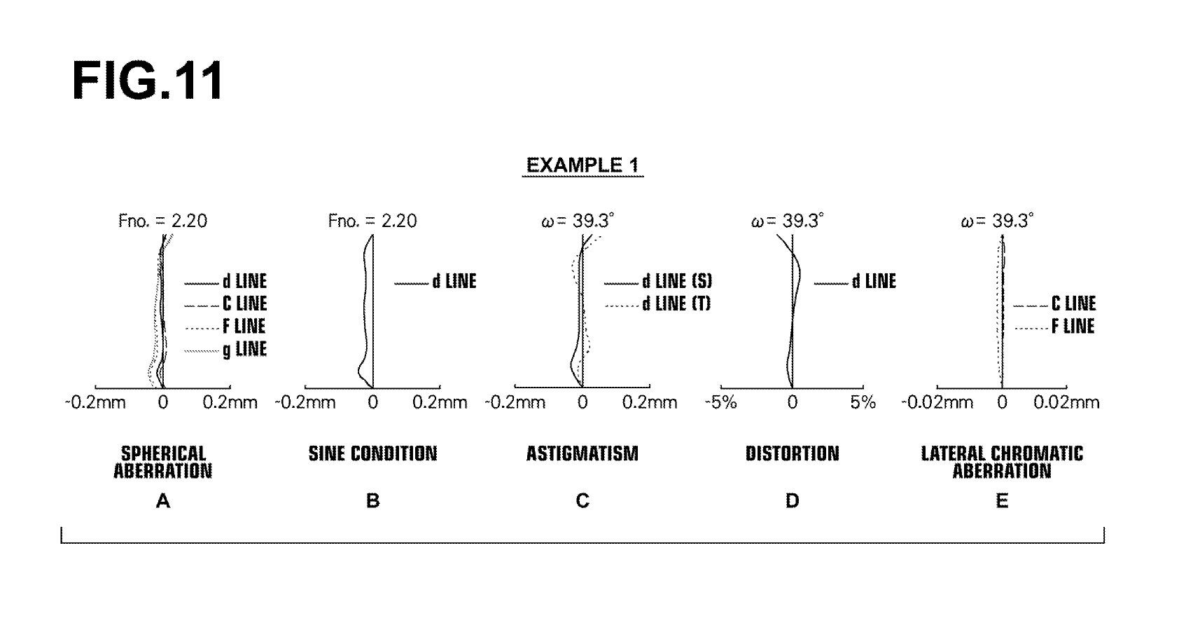

A through E of FIG. 11 are diagrams that illustrate the spherical aberration, the amount of sine condition violation (indicated as “SINE CONDITION” in the drawing), the astigmatic aberration, the distortion, and the lateral chromatic aberration of the imaging lens of Example 1, respectively. Each of the diagrams that illustrate the spherical aberration, the amount of sine condition violation, the astigmatic aberration (field curvature), and the distortion illustrate aberrations using the d line (wavelength: 587.56 nm) as a standard wavelength. The diagrams that illustrate spherical aberration and lateral chromatic aberration also show aberrations related to the F line (wavelengths: 486.1 nm) and the C line (wavelength: 656.27 nm). In addition, the diagram that illustrates spherical aberration also show aberrations related to the g line (wavelength: 435.83 nm). In the diagrams that illustrate astigmatic aberration, aberration in the sagittal direction (S) is indicated by a solid line, while aberration in the tangential direction (T) is indicated by a broken line. In addition, “Fno.” denotes F numbers, and “ω” denotes half angles of view.

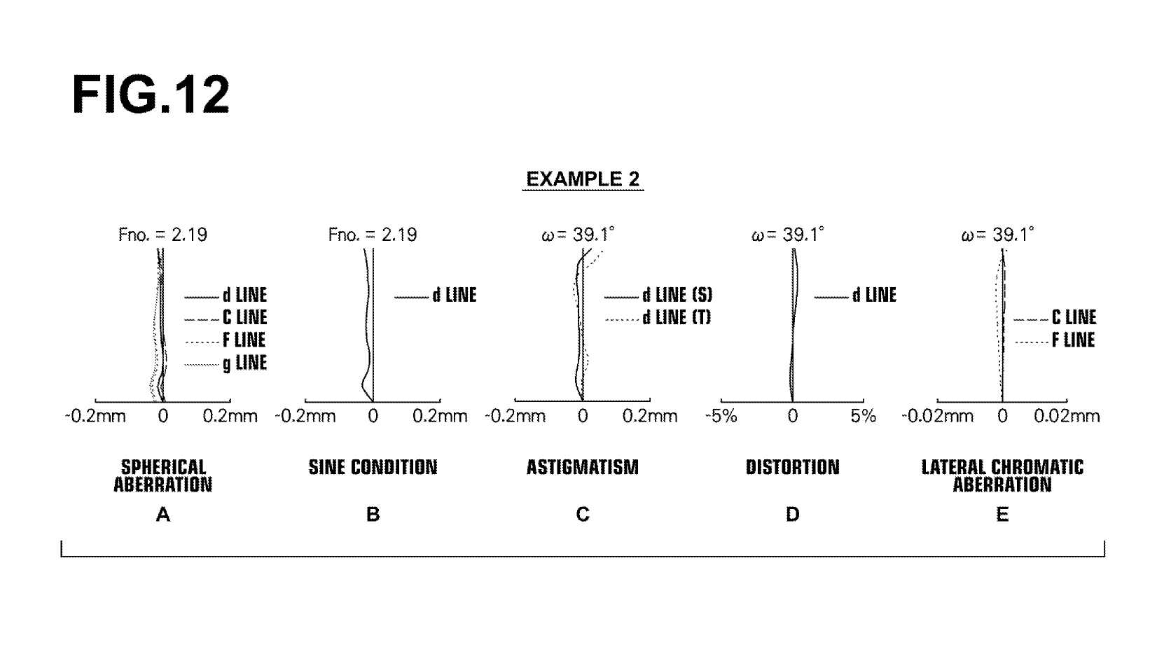

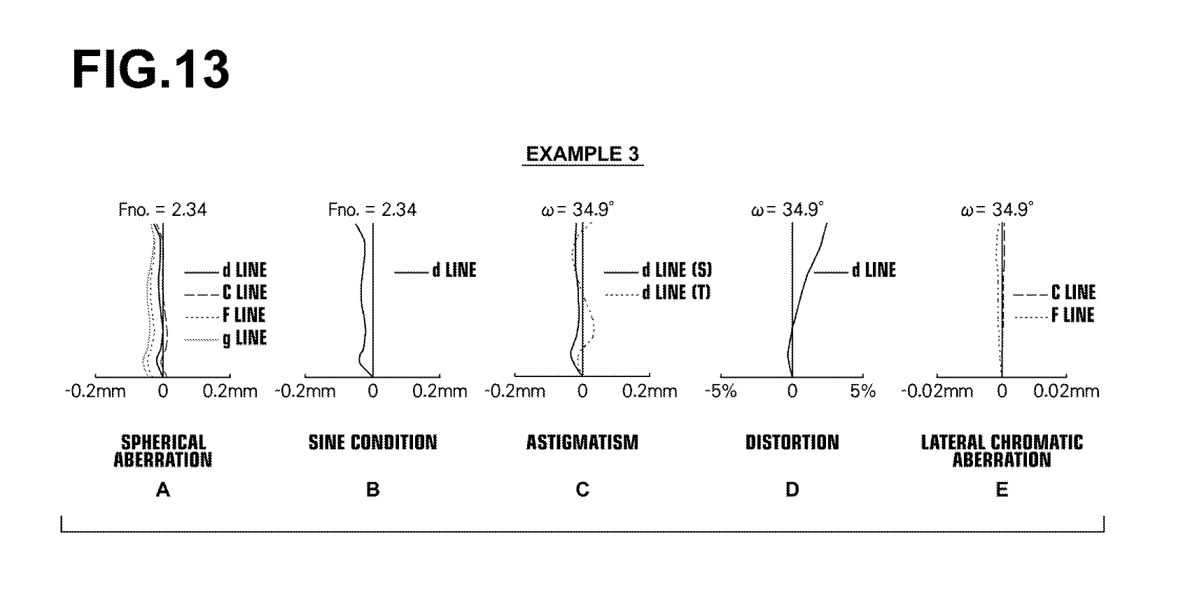

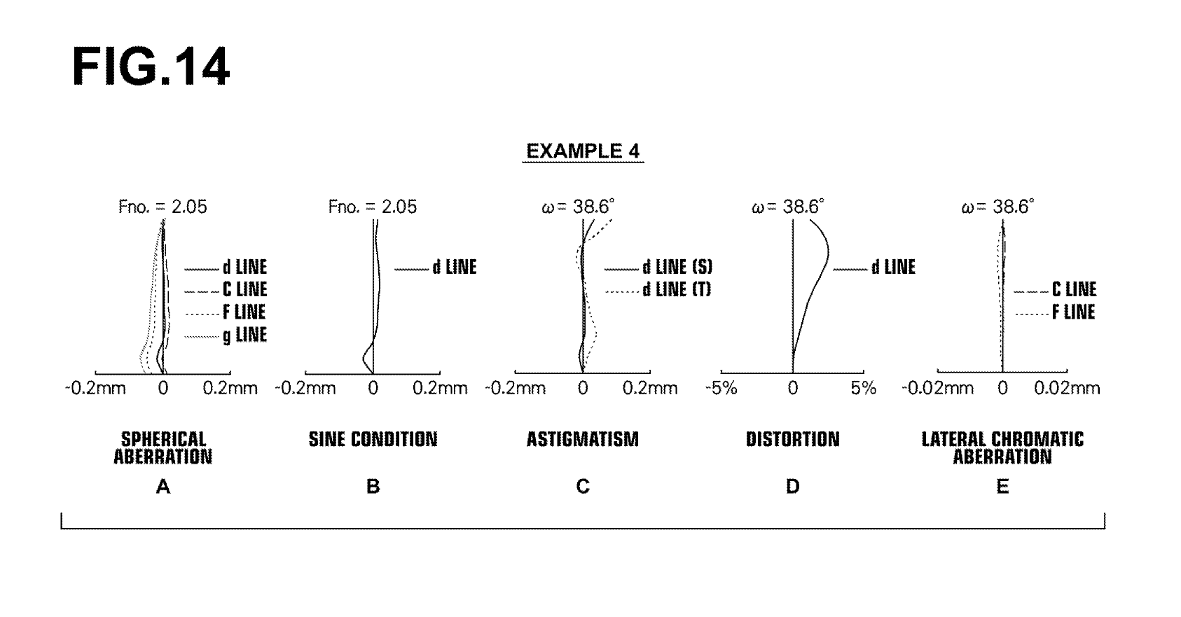

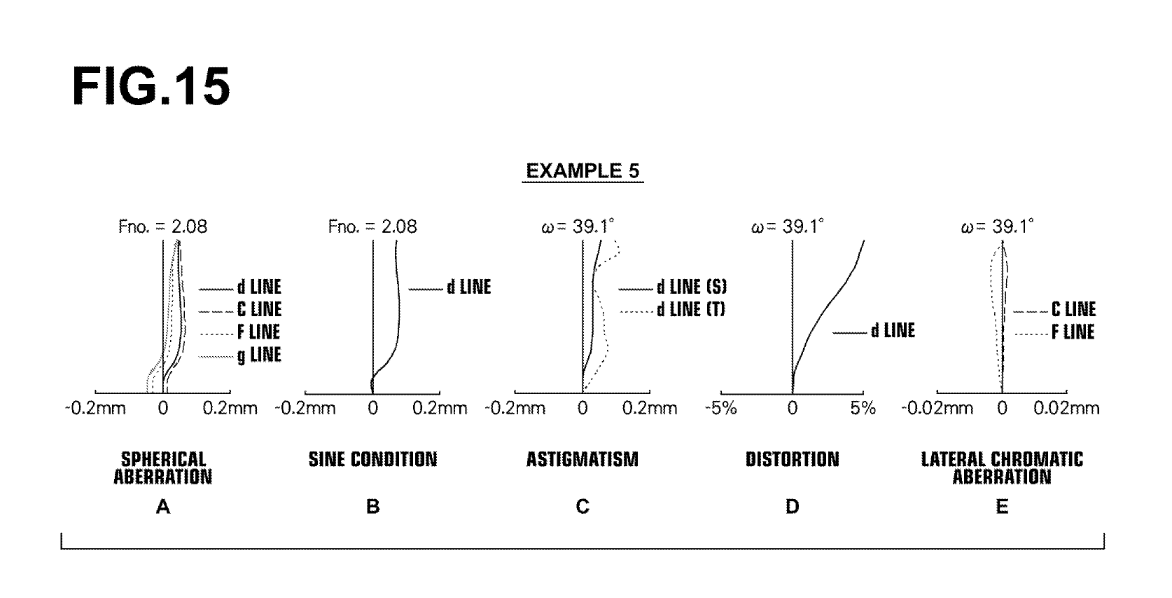

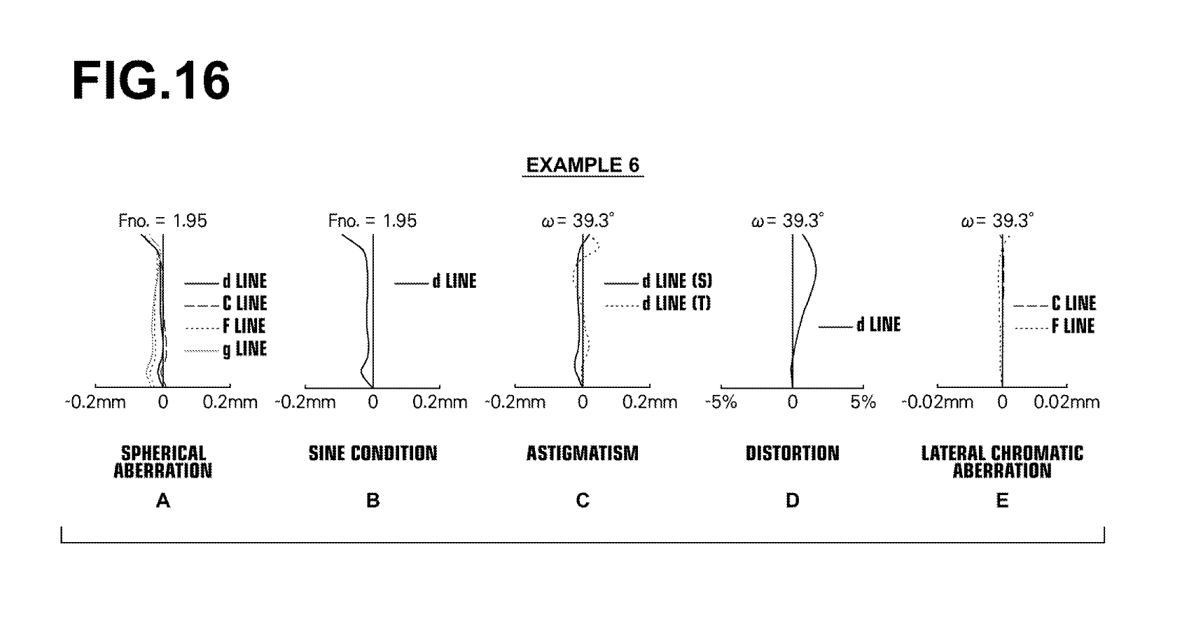

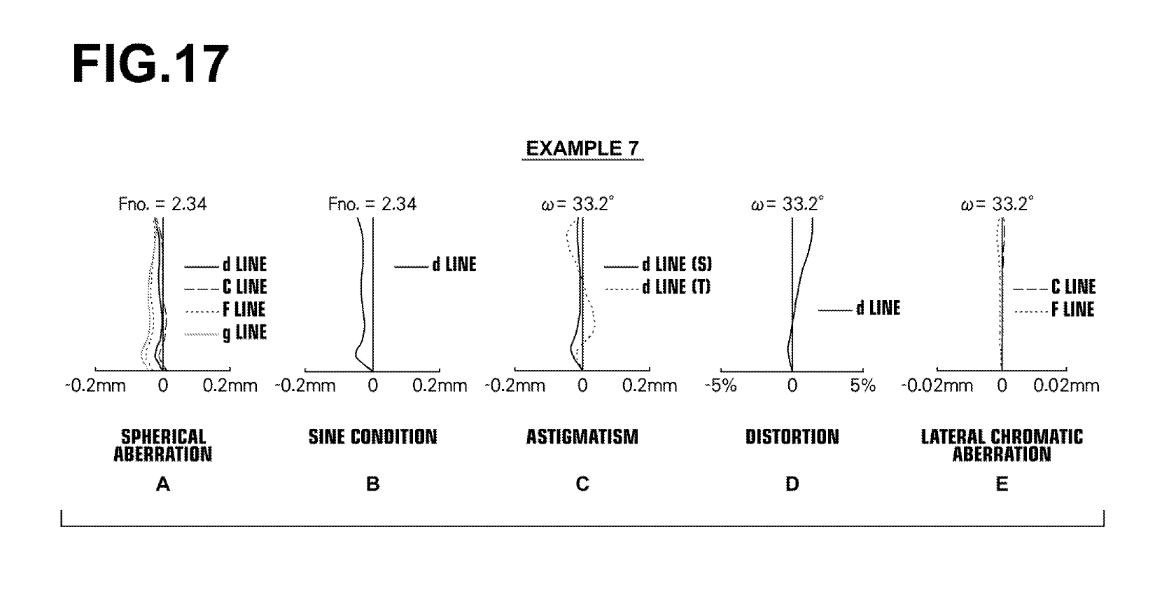

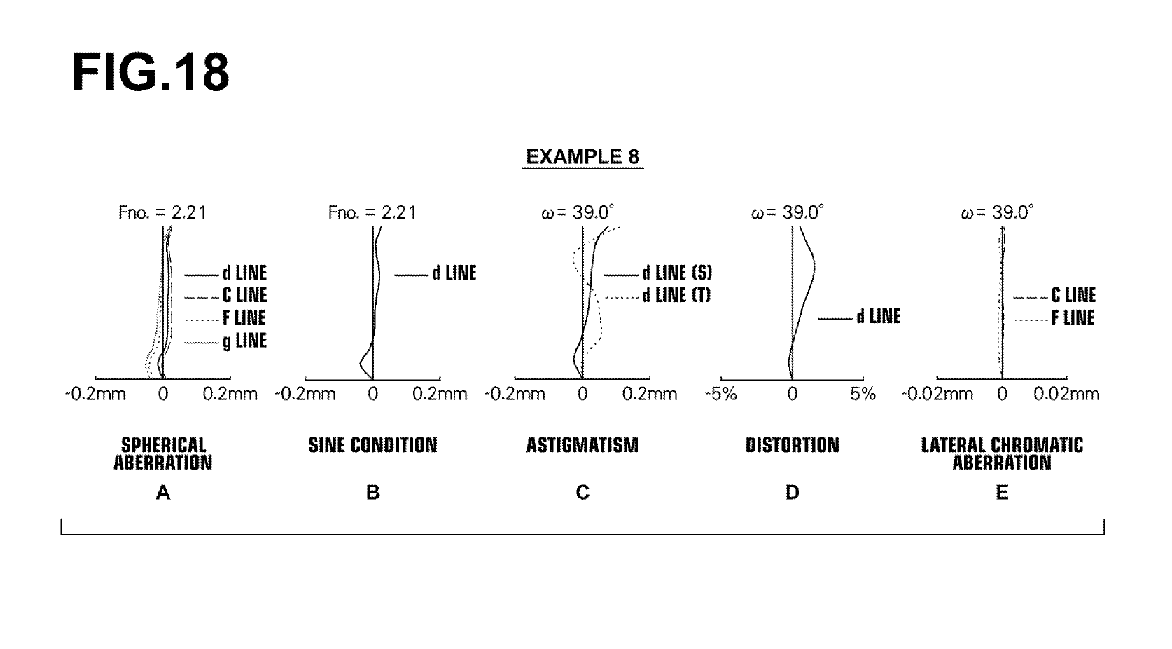

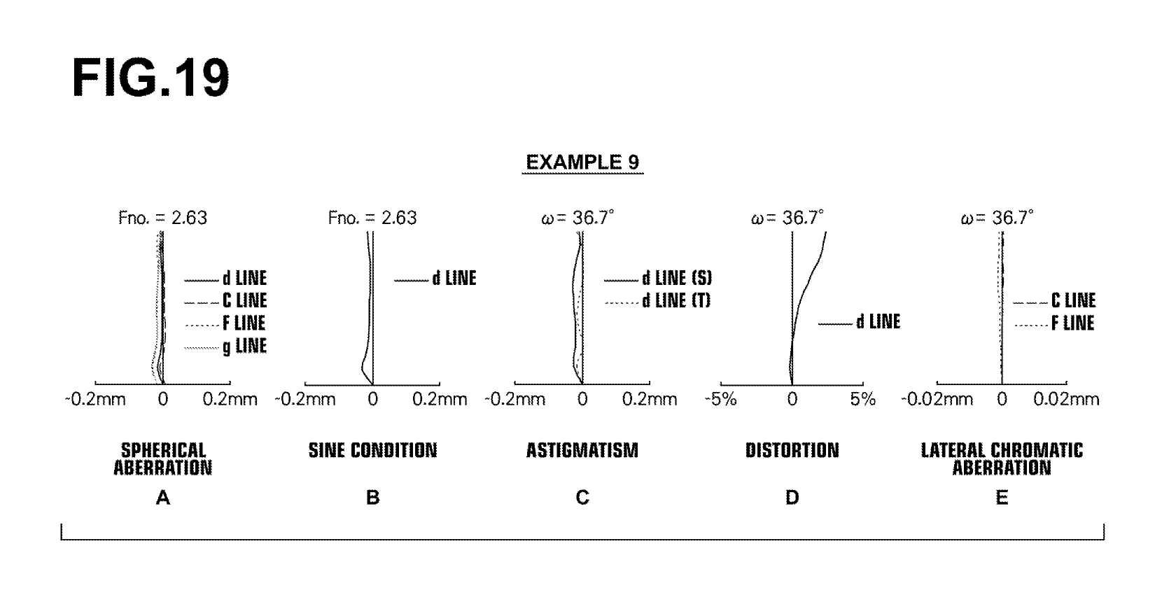

Similarly, the aberrations of the imaging lens of Example 2 are illustrated in A through E of FIG. 12. Similarly, the aberrations of the imaging lenses of Example 3 through Example 9 are illustrated in A through E of FIG. 13 through A through E of FIG. 19.

In addition, Table 19 shows values corresponding to Conditional Formulae (1) through (9) of Examples 1 through 9.

As can be understood from each set of numerical value data and from the diagrams that illustrate aberrations, each of the Examples realizes a low F number and high imaging performance, while shortening the total length of the lens system.

Note that the imaging lens of the present invention is not limited to the embodiments and Examples described above, and various modifications are possible. For example, the values of the radii of curvature, the distances among surfaces, the refractive indices, the Abbe's numbers, the aspherical surface coefficients, etc., are not limited to the numerical values indicated in connection with the Examples, and may be other values.

In addition, the Examples are described under the presumption that they are to be utilized with fixed focus. However, it is also possible for configurations capable of adjusting focus to be adopted. It is possible to adopt a configuration, in which the entirety of the lens system is fed out or a portion of the lenses is moved along the optical axis to enable automatic focus, for example.

TABLE 1
Example 1
f = 6.27, Bf = 1.59, FNo. = 2.20, 2ω = 78.6, α = 30.26, TL = 8.310

| Si | Ri | Di | Ndj | νdj |
|---|---|---|---|---|
| 1 (aperture stop) | ∞ | −0.254 | | |
| 2* | 3.3212 | 0.836 | 1.68930 | 53.08 |
| 3* | 7.4728 | 0.518 | | |
| 4* | 13.0663 | 0.504 | 1.63351 | 23.63 |
| 5* | 4.2161 | 0.249 | | |
| 6* | 5.8852 | 1.012 | 1.53391 | 55.89 |
| 7* | −22.4094 | 0.100 | | |
| 8* | −136.5620 | 0.646 | 1.63351 | 23.63 |
| 9* | 52.3988 | 0.610 | | |
| 10* | 12.3058 | 1.132 | 1.53391 | 55.89 |
| 11* | −2.2916 | 0.205 | | |
| 12* | −12.7145 | 0.910 | 1.53391 | 55.89 |
| 13* | 1.8093 | 1.050 | | |
| 14 | ∞ | 0.250 | 1.51633 | 64.14 |
| 15 | ∞ | 0.373 | | |

*aspherical surface

TABLE 2
Example 2
f = 6.23, Bf = 1.55, FNo. = 2.19, 2ω = 78.2, α = 33.02, TL = 8.311

| Si | Ri | Di | Ndj | νdj |
|---|---|---|---|---|
| 1 (aperture stop) | ∞ | −0.254 | | |
| 2* | 3.2604 | 0.995 | 1.68930 | 53.08 |
| 3* | 7.1301 | 0.526 | | |
| 4* | 14.9405 | 0.523 | 1.63351 | 23.63 |
| 5* | 4.2339 | 0.182 | | |
| 6* | 5.8040 | 1.087 | 1.53391 | 55.89 |
| 7* | −25.4405 | 0.162 | | |
| 8* | −33.6405 | 0.588 | 1.63351 | 23.63 |
| 9* | 106.4826 | 0.404 | | |
| 10* | 8.7773 | 1.221 | 1.53391 | 55.89 |
| 11* | −2.3220 | 0.258 | | |
| 12* | −13.2096 | 0.816 | 1.53391 | 55.89 |
| 13* | 1.7981 | 1.050 | | |
| 14 | ∞ | 0.250 | 1.51633 | 64.14 |
| 15 | ∞ | 0.334 | | |

*aspherical surface

TABLE 3
Example 3
f = 7.11, Bf = 1.82, FNo. = 2.34, 2ω = 69.8, α = 35.20, TL = 9.459

| Si | Ri | Di | Ndj | νdj |
|---|---|---|---|---|
| 1 (aperture stop) | ∞ | −0.199 | | |
| 2* | 3.8216 | 1.134 | 1.68930 | 53.08 |
| 3* | 7.9118 | 0.647 | | |
| 4* | 14.8245 | 0.591 | 1.63351 | 23.63 |
| 5* | 5.4020 | 0.254 | | |
| 6* | 7.7374 | 1.116 | 1.53391 | 55.89 |
| 7* | −26.1338 | 0.252 | | |
| 8* | −114.0339 | 0.504 | 1.63351 | 23.63 |
| 9* | 28.4301 | 0.508 | | |
| 10* | 14.2071 | 1.306 | 1.53391 | 55.89 |
| 11* | −2.6693 | 0.379 | | |
| 12* | −30.0206 | 0.946 | 1.53391 | 55.89 |
| 13* | 2.1516 | 1.200 | | |
| 14 | ∞ | 0.306 | 1.51633 | 64.14 |
| 15 | ∞ | 0.420 | | |

*aspherical surface

TABLE 4
Example 4
f = 6.29, Bf = 1.75, FNo. = 2.05, 2ω = 77.2, α = 31.78, TL = 8.122

| Si | Ri | Di | Ndj | νdj |
|---|---|---|---|---|
| 1 (aperture stop) | ∞ | −0.299 | | |
| 2* | 3.1546 | 1.140 | 1.68930 | 53.08 |
| 3* | 5.9579 | 0.505 | | |
| 4* | 11.3506 | 0.503 | 1.63351 | 23.63 |
| 5* | 4.6277 | 0.196 | | |
| 6* | 7.4236 | 0.953 | 1.53391 | 55.89 |
| 7* | −21.8733 | 0.212 | | |
| 8* | −44.6333 | 0.500 | 1.63351 | 23.63 |
| 9* | 45.6676 | 0.345 | | |
| 10* | 13.3617 | 1.055 | 1.53391 | 55.89 |
| 11* | −2.1234 | 0.293 | | |
| 12* | −44.2208 | 0.667 | 1.53391 | 55.89 |
| 13* | 1.6911 | 1.174 | | |
| 14 | ∞ | 0.250 | 1.51633 | 64.14 |
| 15 | ∞ | 0.414 | | |

*aspherical surface

TABLE 5
Example 5
f = 5.94, Bf = 1.53, FNo. = 2.08, 2ω = 78.2, α = 32.32, TL = 7.956

| Si | Ri | Di | Ndj | νdj |
|---|---|---|---|---|
| 1 (aperture stop) | ∞ | −0.249 | | |
| 2* | 3.1325 | 1.053 | 1.68930 | 53.08 |
| 3* | 6.1386 | 0.515 | | |
| 4* | 10.8851 | 0.500 | 1.63351 | 23.63 |
| 5* | 4.4614 | 0.224 | | |
| 6* | 6.7349 | 0.932 | 1.53391 | 55.89 |
| 7* | −28.2395 | 0.179 | | |
| 8* | 158.6888 | 0.541 | 1.63351 | 23.63 |
| 9* | 25.5674 | 0.391 | | |
| 10* | 12.3918 | 1.133 | 1.53391 | 55.89 |
| 11* | −2.1106 | 0.239 | | |
| 12* | −28.3114 | 0.721 | 1.53391 | 55.89 |
| 13* | 1.7126 | 1.174 | | |
| 14 | ∞ | 0.250 | 1.51633 | 64.14 |
| 15 | ∞ | 0.189 | | |

*aspherical surface

TABLE 6
Example 6
f = 6.17, Bf = 1.62, FNo. = 1.95, 2ω = 78.6, α = 31.23, TL = 8.157

| Si | Ri | Di | Ndj | νdj |
|---|---|---|---|---|
| 1 (aperture stop) | ∞ | −0.249 | | |
| 2* | 3.1544 | 1.048 | 1.68930 | 53.08 |
| 3* | 6.4124 | 0.513 | | |
| 4* | 12.8290 | 0.505 | 1.63351 | 23.63 |
| 5* | 4.4263 | 0.184 | | |
| 6* | 6.5757 | 1.048 | 1.53391 | 55.89 |
| 7* | −23.0755 | 0.123 | | |
| 8* | −51.4118 | 0.510 | 1.63351 | 23.63 |
| 9* | 30.6388 | 0.369 | | |
| 10* | 11.7374 | 1.206 | 1.53391 | 55.89 |
| 11* | −2.1526 | 0.289 | | |
| 12* | −24.7252 | 0.740 | 1.53391 | 55.89 |
| 13* | 1.7521 | 1.050 | | |
| 14 | ∞ | 0.250 | 1.51633 | 64.14 |
| 15 | ∞ | 0.407 | | |

*aspherical surface

TABLE 7
Example 7
f = 7.64, Bf = 2.04, FNo. = 2.34, 2ω = 66.4, α = 35.04, TL = 9.971

| Si | Ri | Di | Ndj | νdj |
|---|---|---|---|---|
| 1 (aperture stop) | ∞ | −0.306 | | |
| 2* | 3.8403 | 1.179 | 1.68930 | 53.08 |
| 3* | 7.8494 | 0.653 | | |
| 4* | 14.5622 | 0.606 | 1.63351 | 23.63 |
| 5* | 5.4338 | 0.296 | | |
| 6* | 8.3248 | 1.223 | 1.53391 | 55.89 |
| 7* | −27.0784 | 0.167 | | |
| 8* | −61.6489 | 0.606 | 1.63351 | 23.63 |
| 9* | 27.9604 | 0.461 | | |
| 10* | 14.6445 | 1.417 | 1.53391 | 55.89 |
| 11* | −2.6994 | 0.378 | | |
| 12* | −32.5606 | 0.946 | 1.33391 | 55.89 |
| 13* | 2.1861 | 1.441 | | |
| 14 | ∞ | 0.306 | 1.51633 | 64.14 |
| 15 | ∞ | 0.396 | | |

*aspherical surface

TABLE 8
Example 8
f = 6.23, Bf = 1.56, FNo. = 2.21, 2ω = 78.0, α = 31.69, TL = 8.259

| Si | Ri | Di | Ndj | νdj |
|---|---|---|---|---|
| 1 (aperture stop) | ∞ | −0.254 | | |
| 2* | 3.3218 | 0.833 | 1.68930 | 53.08 |
| 3* | 7.4685 | 0.518 | | |
| 4* | 13.1223 | 0.503 | 1.63351 | 23.63 |
| 5* | 4.2184 | 0.250 | | |
| 6* | 5.8785 | 1.005 | 1.53391 | 55.89 |
| 7* | −22.3031 | 0.100 | | |
| 8* | −129.7328 | 0.645 | 1.53391 | 55.89 |
| 9* | 51.5256 | 0.608 | | |
| 10* | 12.2841 | 1.126 | 1.53391 | 55.89 |
| 11* | −2.2924 | 0.204 | | |
| 12* | −12.4716 | 0.910 | 1.53391 | 55.89 |
| 13* | 1.8035 | 1.050 | | |
| 14 | ∞ | 0.250 | 1.51633 | 64.14 |
| 15 | ∞ | 0.342 | | |

*aspherical surface

TABLE 9
Example 9
f = 6.56, Bf = 1.93, FNo. = 2.63, 2ω = 73.4, α = 36.30, TL = 8.818

| Si | Ri | Di | Ndj | νdj |
|---|---|---|---|---|
| 1* | 3.4136 | 0.934 | 1.68930 | 53.08 |
| 2* | 7.5305 | 0.100 | | |
| 3 (aperture stop) | ∞ | 0.500 | | |
| 4* | 13.8951 | 0.500 | 1.63351 | 23.63 |
| 5* | 4.2981 | 0.166 | | |
| 6* | 5.8930 | 1.210 | 1.53391 | 55.89 |
| 7* | 84.8359 | 0.340 | | |
| 8* | −16.9928 | 0.600 | 1.63351 | 23.63 |
| 9* | 105.4854 | 0.198 | | |
| 10* | 8.6855 | 1.282 | 1.53391 | 55.89 |
| 11* | −1.8651 | 0.233 | | |
| 12* | −22.4084 | 0.824 | 1.53391 | 55.89 |
| 13* | 1.6535 | 1.050 | | |
| 14 | ∞ | 0.250 | 1.51633 | 64.14 |
| 15 | ∞ | 0.716 | | |

*aspherical surface

TABLE 10
Example 1: Aspherical Surface Data

| Surface | | | | | |
|---|---|---|---|---|---|
| Number | K | A3 | A4 | A5 | A6 |
| 2 | 9.181080E−01 | −6.112140E−04 | 3.812300E−03 | −1.106560E−02 | 1.758650E−02 |
| 3 | 6.469930E+00 | −1.754590E−03 | −8.439250E−03 | 6.962880E−03 | −3.039750E−02 |
| 4 | 3.961090E+00 | 3.025840E−02 | −2.499630E−01 | 6.048510E−01 | −9.987940E−01 |
| 5 | −1.827470E+01 | 3.452390E−02 | −1.730270E−01 | 3.590440E−01 | −4.944040E−01 |
| 6 | −5.191030E+00 | −7.367690E−03 | 1.129150E−02 | −4.498390E−02 | 5.853740E−02 |
| 7 | −6.750740E+02 | −1.806440E−02 | 7.101540E−02 | −1.932130E−01 | 2.229430E−01 |
| 8 | 1.697730E+01 | 7.265190E−03 | −1.405580E−02 | −1.065980E−02 | 1.892400E−03 |
| 9 | −2.309000E+01 | 8.234620E−04 | −1.248470E−02 | −5.546030E−03 | 2.493380E−03 |
| 10 | 8.938730E−01 | 1.029730E−02 | −3.198590E−02 | 3.476040E−02 | −3.296760E−02 |
| 11 | −4.567280E+00 | 1.250470E−02 | −8.088390E−03 | −6.962380E−03 | 1.616590E−02 |
| 12 | −1.119380E+01 | 2.689880E−02 | −8.461850E−02 | 4.109400E−02 | −3.973530E−03 |
| 13 | −4.985500E+00 | 2.466060E−02 | −6.327030E−02 | 3.580870E−02 | −8.478990E−03 |
| | A7 | A8 | A9 | A10 | |
| 2 | −1.530780E−02 | 6.937470E−03 | −1.202800E−03 | −1.446430E−04 | |
| 3 | 4.270990E−02 | −2.817470E−02 | 7.378920E−03 | −5.431080E−04 | |
| 4 | 9.764160E−01 | −5.462880E−01 | 1.582340E−01 | −1.778910E−02 | |
| 5 | 4.172900E−01 | −2.066920E−01 | 5.462800E−02 | −5.775820E−03 | |
| 6 | −4.262970E−02 | 1.813650E−02 | −4.209830E−03 | 4.015930E−04 | |
| 7 | −1.553440E−01 | 6.538860E−02 | −1.476630E−02 | 1.361820E−03 | |
| 8 | 2.735290E−03 | 1.080130E−04 | −2.078870E−04 | −3.055900E−05 | |
| 9 | 1.213780E−03 | −2.224410E−04 | −7.286990E−05 | 8.790230E−06 | |
| 10 | 1.758930E−02 | −5.397810E−03 | 8.297800E−04 | −3.910480E−05 | |
| 11 | −1.221500E−02 | 4.789950E−03 | −9.425670E−04 | 7.293160E−05 | |
| 12 | −2.904620E−03 | 1.393410E−03 | −2.686490E−04 | 1.973240E−05 | |
| 13 | 1.238330E−04 | 3.699560E−04 | −7.619310E−05 | 5.042650E−06 | |

TABLE 11
Example 2: Aspherical Surface Data

| Surface | | | | | |
|---|---|---|---|---|---|
| Number | K | A3 | A4 | A5 | A6 |
| 2 | 9.420460E−01 | −6.552680E−04 | 4.363050E−03 | −1.217080E−02 | 1.833340E−02 |
| 3 | 6.458630E+00 | −1.225300E−03 | −8.711830E−03 | 6.645400E−03 | −3.098360E−02 |
| 4 | 3.934280E+00 | 3.230900E−02 | −2.555820E−01 | 6.404020E−01 | −1.078930E+00 |
| 5 | −1.821240E+01 | 3.382400E−02 | −1.812340E−01 | 4.107110E−01 | −5.849820E−01 |
| 6 | −5.164160E+00 | −9.944010E−03 | 9.849480E−03 | −3.405860E−02 | 4.573050E−02 |
| 7 | −6.710760E+02 | −1.523470E−02 | 6.810950E−02 | −1.765810E−01 | 2.017530E−01 |
| 8 | −1.285380E+01 | 1.386970E−02 | −1.000450E−02 | −1.057150E−02 | 1.359780E−03 |
| 9 | −2.395330E+01 | 1.099870E−02 | −1.740120E−02 | −8.169650E−03 | 3.835760E−03 |
| 10 | 8.246960E−01 | 1.578460E−02 | −3.854530E−02 | 3.193820E−02 | −3.187520E−02 |
| 11 | −4.565170E+00 | 1.691650E−02 | −1.050790E−02 | −1.125860E−02 | 2.122900E−02 |
| 12 | −1.093350E+01 | 2.786020E−02 | −9.020880E−02 | 4.206090E−02 | −3.758550E−03 |
| 13 | −5.038870E+00 | 2.185820E−02 | −6.140630E−02 | 3.502700E−02 | −8.246540E−03 |
| | A7 | A8 | A9 | A10 | |
| 2 | −1.470450E−02 | 6.172950E−03 | −1.271810E−03 | 4.642640E−05 | |
| 3 | 4.375690E−02 | −2.951900E−02 | 7.807400E−03 | −4.803740E−04 | |
| 4 | 1.065570E+00 | −6.026920E−01 | 1.767550E−01 | −2.004700E−02 | |
| 5 | 5.012960E−01 | −2.532470E−01 | 6.917860E−02 | −7.667060E−03 | |
| 6 | −3.264610E−02 | 1.310290E−02 | −2.849170E−03 | 2.669710E−04 | |
| 7 | −1.388550E−01 | 5.726680E−02 | −1.269470E−02 | 1.153220E−03 | |
| 8 | 2.076140E−03 | −3.686500E−05 | −1.267250E−04 | −6.044170E−06 | |
| 9 | 1.455570E−03 | −4.088470E−04 | −7.982680E−05 | 1.822670E−05 | |
| 10 | 1.790120E−02 | −5.416720E−03 | 8.031680E−04 | −3.738070E−05 | |
| 11 | −1.715280E−02 | 7.300660E−03 | −1.500030E−03 | 1.170730E−04 | |
| 12 | −2.988630E−03 | 1.477510E−03 | −2.991780E−04 | 2.288630E−05 | |
| 13 | 9.912700E−05 | 3.577610E−04 | −7.136750E−05 | 4.601280E−06 | |

TABLE 12
Example 3: Aspherical Surface Data

| Surface | | | | | |
|---|---|---|---|---|---|
| Number | K | A3 | A4 | A5 | A6 |
| 2 | 9.965600E−01 | −4.893440E−04 | 2.678740E−03 | −6.274750E−03 | 7.742280E−03 |
| 3 | 6.442420E+00 | −1.765780E−03 | −3.024450E−03 | 1.826310E−03 | −1.252210E−02 |
| 4 | 3.364040E+00 | 2.191480E−02 | −1.505170E−01 | 3.235100E−01 | −4.595280E−01 |
| 5 | −1.819970E+01 | 2.737690E−02 | −1.120150E−01 | 2.111910E−01 | −2.535940E−01 |
| 6 | −4.675240E+00 | −5.125990E−03 | 7.098750E−03 | −1.770290E−02 | 1.973340E−02 |
| 7 | −6.671330E+02 | −1.394630E−02 | 4.200210E−02 | −8.850600E−02 | 8.701310E−02 |
| 8 | −5.000000E+01 | 9.530300E−03 | −6.696390E−03 | −4.711170E−03 | 9.552610E−04 |
| 9 | −1.199220E+01 | 7.701440E−03 | −9.200280E−03 | −4.719520E−03 | 1.255900E−03 |
| 10 | −2.792220E+00 | 1.055480E−02 | −2.231140E−02 | 1.870670E−02 | −1.606570E−02 |
| 11 | −4.467530E+00 | 5.054550E−03 | −7.676000E−03 | −4.021600E−03 | 1.067090E−02 |
| 12 | −1.264930E+01 | 1.316390E−02 | −5.232570E−02 | 2.360160E−02 | −2.437280E−03 |
| 13 | −4.995820E+00 | 1.427170E−02 | −3.413590E−02 | 1.628640E−02 | −3.238530E−03 |
| | A7 | A8 | A9 | A10 | |
| 2 | −4.998540E−03 | 1.659830E−03 | −3.051550E−04 | 3.230750E−05 | |
| 3 | 1.558480E−02 | −8.649300E−03 | 1.737440E−03 | −3.434650E−05 | |
| 4 | 3.798850E−01 | −1.800430E−01 | 4.443010E−02 | −4.269540E−03 | |
| 5 | 1.835320E−01 | −7.835340E−02 | 1.806010E−02 | −1.684880E−03 | |
| 6 | −1.191070E−02 | 4.075970E−03 | −7.486320E−04 | 5.730830E−05 | |
| 7 | −5.071000E−02 | 1.747590E−02 | −3.251210E−03 | 2.519660E−04 | |
| 8 | 6.354920E−04 | −6.849650E−05 | −2.771800E−05 | 1.647890E−06 | |
| 9 | 6.318990E−04 | −7.709160E−05 | −2.490400E−05 | 1.991440E−06 | |
| 10 | 7.577690E−03 | −1.967280E−03 | 2.538950E−04 | −1.027200E−05 | |
| 11 | −7.710300E−03 | 2.789840E−03 | −4.963090E−04 | 3.435240E−05 | |
| 12 | −1.230190E−03 | 5.277850E−04 | −8.313230E−05 | 4.833180E−06 | |
| 13 | 3.973640E−05 | 9.638320E−05 | −1.606540E−05 | 8.487720E−07 | |

TABLE 13
Example 4: Aspherical Surface Data

| Surface | | | | | |
|---|---|---|---|---|---|
| Number | K | A3 | A4 | A5 | A6 |
| 2 | 9.935940E−01 | 9.292470E−04 | 2.534140E−03 | −1.186180E−02 | 1.763310E−02 |
| 3 | 6.459920E+00 | −1.536170E−03 | −6.581680E−03 | 2.584180E−03 | −3.648240E−02 |
| 4 | 3.717870E+00 | 3.169870E−02 | −2.704540E−01 | 7.064020E−01 | −1.223970E+00 |
| 5 | −1.820120E+01 | 3.834560E−02 | −2.081670E−01 | 4.843800E−01 | −7.161530E−01 |
| 6 | −4.244720E+00 | −7.180580E−03 | 1.231070E−02 | −3.772560E−02 | 4.867180E−02 |
| 7 | −7.638860E+02 | −2.159710E−02 | 7.650510E−02 | −2.001490E−01 | 2.413250E−01 |
| 8 | 1.916430E+01 | 1.110630E−02 | −1.376700E−02 | −1.044980E−02 | 2.928230E−03 |
| 9 | 2.954810E−01 | 1.237840E−02 | −1.912410E−02 | −1.248190E−02 | 4.327370E−03 |
| 10 | 8.056450E−01 | 1.620170E−02 | −3.735580E−02 | 3.757800E−02 | −4.091700E−02 |
| 11 | −4.575040E+00 | 1.176700E−02 | −1.160440E−02 | −9.874060E−03 | 3.072180E−02 |
| 12 | −9.532450E+00 | 1.036690E−02 | −9.107490E−02 | 5.025730E−02 | −5.605140E−03 |
| 13 | −4.732560E+00 | 7.265520E−03 | −6.172500E−02 | 4.031510E−02 | −1.029530E−02 |
| | A7 | A8 | A9 | A10 | |
| 2 | −1.245440E−02 | 4.768490E−03 | −1.136080E−03 | 1.440970E−04 | |
| 3 | 5.799260E−02 | −3.914020E−02 | 9.492390E−03 | −2.361640E−04 | |
| 4 | 1.234330E+00 | −7.134830E−01 | 2.143570E−01 | −2.498960E−02 | |
| 5 | 6.361000E−01 | −3.334400E−01 | 9.469270E−02 | −1.093290E−02 | |
| 6 | −3.570970E−02 | 1.499140E−02 | −3.290560E−03 | 2.885040E−04 | |
| 7 | −1.727280E−01 | 7.303230E−02 | −1.664140E−02 | 1.576780E−03 | |
| 8 | 2.154840E−03 | −3.035280E−04 | −1.406090E−04 | 1.061830E−05 | |
| 9 | 2.473140E−03 | −4.556930E−04 | −1.465610E−04 | 1.937290E−05 | |
| 10 | 2.297920E−02 | −6.978660E−03 | 1.098230E−03 | −6.177460E−05 | |
| 11 | −2.795440E−02 | 1.258310E−02 | −2.764850E−03 | 2.353950E−04 | |
| 12 | −3.762560E−03 | 1.834910E−03 | −3.492640E−04 | 2.537380E−05 | |
| 13 | 1.551330E−04 | 4.725050E−04 | −9.540920E−05 | 6.051270E−06 | |

TABLE 14
Example 5: Aspherical Surface Data

| Surface | | | | | |
|---|---|---|---|---|---|
| Number | K | A3 | A4 | A5 | A6 |
| 2 | 1.004870E+00 | −1.260440E−03 | 4.678280E−03 | −1.274060E−02 | 1.919610E−02 |
| 3 | 6.462860E+00 | −3.490550E−03 | −4.216580E−03 | 3.422520E−03 | −3.782340E−02 |
| 4 | 3.590180E+00 | 3.173150E−02 | −2.778100E−01 | 7.223060E−01 | −1.251740E+00 |
| 5 | −1.816730E+01 | 3.877030E−02 | −2.087640E−01 | 4.794430E−01 | −7.050950E−01 |
| 6 | −4.616140E+00 | −7.811130E−03 | 1.208390E−02 | −3.595480E−02 | 4.695230E−02 |
| 7 | −7.576210E+02 | −1.531400E−02 | 7.810440E−02 | −2.004680E−01 | 2.389400E−01 |
| 8 | 5.000000E+01 | 1.408720E−02 | −1.191460E−02 | −1.094340E−02 | 2.246540E−03 |
| 9 | 1.857630E−01 | 1.472030E−02 | −1.824370E−02 | −1.251510E−02 | 4.081570E−03 |
| 10 | 1.050490E+00 | 1.789150E−02 | −3.930710E−02 | 3.907360E−02 | −4.318140E−02 |
| 11 | −4.590360E+00 | 1.099430E−02 | −1.214450E−02 | −1.020460E−02 | 3.135950E−02 |
| 12 | −9.621410E+00 | 1.699130E−02 | −9.012450E−02 | 4.925150E−02 | −5.913030E−03 |
| 13 | −4.637070E+00 | 1.337380E−02 | −6.222380E−02 | 3.937680E−02 | −1.001700E−02 |
| | A7 | A8 | A9 | A10 | |
| 2 | −1.463170E−02 | 5.897760E−03 | −1.376160E−03 | 1.663330E−04 | |
| 3 | 5.775010E−02 | −3.870000E−02 | 9.490190E−03 | −2.741370E−04 | |
| 4 | 1.269640E+00 | −7.384720E−01 | 2.225230E−01 | −2.587700E−02 | |
| 5 | 6.264370E−01 | −3.283210E−01 | 9.285560E−02 | −1.062060E−02 | |
| 6 | −3.427650E−02 | 1.423630E−02 | −3.104730E−03 | 2.721440E−04 | |
| 7 | −1.710050E−01 | 7.238600E−02 | −1.647310E−02 | 1.555720E−03 | |
| 8 | 2.177490E−03 | −2.010300E−04 | −1.405100E−04 | 4.931970E−06 | |
| 9 | 2.405420E−03 | −4.304210E−04 | −1.406610E−04 | 1.863480E−05 | |
| 10 | 2.461980E−02 | −7.559910E−03 | 1.195400E−03 | −6.672150E−05 | |
| 11 | −2.854370E−02 | 1.289680E−02 | −2.842880E−03 | 2.427330E−04 | |
| 12 | −3.714320E−03 | 1.887120E−03 | −3.604340E−04 | 2.575970E−05 | |
| 13 | 1.736500E−04 | 4.570480E−04 | −9.394820E−05 | 6.059750E−06 | |

TABLE 15
Example 6: Aspherical Surface Data

| Surface | | | | | |
|---|---|---|---|---|---|
| Number | K | A3 | A4 | A5 | A6 |
| 2 | 9.995240E−01 | −1.186230E−03 | 4.915120E−03 | −1.112980E−02 | 1.572990E−02 |
| 3 | 6.473700E+00 | −3.677140E−03 | −3.980720E−03 | 3.866670E−03 | −3.580890E−02 |
| 4 | 3.670570E+00 | 3.431450E−02 | −2.740820E−01 | 7.082570E−01 | −1.224570E+00 |
| 5 | −1.819810E+01 | 4.192240E−02 | −2.035190E−01 | 4.688040E−01 | −6.901900E−01 |
| 6 | −4.448900E+00 | −6.663560E−03 | 1.582220E−02 | −4.351520E−02 | 5.840530E−02 |
| 7 | −6.892040E+02 | −2.115500E−02 | 7.762750E−02 | −1.960520E−01 | 2.354240E−01 |
| 8 | −8.670470E+00 | 1.097880E−02 | −1.130370E−02 | −9.762350E−03 | 2.247180E−03 |
| 9 | −2.964540E−01 | 1.095760E−02 | −1.781300E−02 | −9.940670E−03 | 3.808590E−03 |
| 10 | 8.502060E−01 | 1.528260E−02 | −4.190720E−02 | 4.059990E−02 | −4.365190E−02 |
| 11 | −4.543800E+00 | 8.782900E−03 | −1.484380E−02 | −9.445250E−03 | 2.902970E−02 |
| 12 | −1.130030E+01 | 2.236720E−02 | −9.603050E−02 | 5.245250E−02 | −6.612700E−03 |
| 13 | −5.057060E+00 | 2.491490E−02 | −6.884140E−02 | 4.092410E−02 | −1.024400E−02 |
| | A7 | A8 | A9 | A10 | |
| 2 | −1.192700E−02 | 4.782130E−03 | −1.075260E−03 | 1.204680E−04 | |
| 3 | 5.291340E−02 | −3.495770E−02 | 8.563840E−03 | −2.855980E−04 | |
| 4 | 1.237590E+00 | −7.162150E−01 | 2.150820E−01 | −2.505200E−02 | |
| 5 | 6.111520E−01 | −3.186040E−01 | 8.966750E−02 | −1.023590E−02 | |
| 6 | −4.473250E−02 | 1.934660E−02 | −4.361150E−03 | 3.939810E−04 | |
| 7 | −1.682310E−01 | 7.093750E−02 | −1.610020E−02 | 1.517810E−03 | |
| 8 | 2.078030E−03 | −2.181230E−04 | −1.396180E−04 | 6.481830E−06 | |
| 9 | 1.990890E−03 | −3.803940E−04 | −1.185760E−04 | 1.590870E−05 | |
| 10 | 2.548430E−02 | −7.971750E−03 | 1.247850E−03 | −6.573260E−05 | |
| 11 | −2.568790E−02 | 1.145180E−02 | −2.497810E−03 | 2.107460E−04 | |
| 12 | −4.039430E−03 | 2.123780E−03 | −4.106260E−04 | 2.937180E−05 | |
| 13 | 1.835750E−04 | 4.794550E−04 | −1.019650E−04 | 6.893900E−06 | |

TABLE 16
Example 7: Aspherical Surface Data

| Surface | | | | | |
|---|---|---|---|---|---|
| Number | K | A3 | A4 | A5 | A6 |
| 2 | 1.000910E+00 | −2.842630E−04 | 2.427120E−03 | −5.396490E−03 | 6.362250E−03 |
| 3 | 6.475200E+00 | −2.210390E−03 | −2.294790E−03 | 1.688600E−03 | −1.265040E−02 |
| 4 | 3.717150E+00 | 2.200150E−02 | −1.508480E−01 | 3.222850E−01 | −4.571520E−01 |
| 5 | −1.820160E+01 | 2.735940E−02 | −1.115050E−01 | 2.096030E−01 | −2.515000E−01 |
| 6 | −4.755220E+00 | −5.016490E−03 | 8.236500E−03 | −1.742650E−02 | 1.919980E−02 |
| 7 | −6.739110E+02 | −1.218230E−02 | 4.217780E−02 | −8.672440E−02 | 8.449770E−02 |
| 8 | −1.067710E+01 | 9.369560E−03 | −6.039320E−03 | −4.611130E−03 | 8.030420E−04 |
| 9 | −1.138030E−01 | 7.344600E−03 | −1.001620E−02 | −4.611270E−03 | 1.431850E−03 |
| 10 | 8.365320E−01 | 1.077300E−02 | −2.294570E−02 | 1.834940E−02 | −1.611220E−02 |
| 11 | −4.549530E+00 | 5.155430E−03 | −7.076650E−03 | −3.992260E−03 | 1.013480E−02 |
| 12 | −1.122520E+01 | 1.401640E−02 | −5.102160E−02 | 2.288750E−02 | −2.358470E−03 |
| 13 | −5.043760E+00 | 1.419810E−02 | −3.461000E−02 | 1.649150E−02 | −3.278410E−03 |
| | A7 | A8 | A9 | A10 | |
| 2 | −3.859710E−03 | 1.246830E−03 | −2.362180E−04 | 2.371120E−05 | |
| 3 | 1.538310E−02 | −8.323300E−03 | 1.663830E−03 | −4.392120E−05 | |
| 4 | 3.781240E−01 | −1.791580E−01 | 4.413200E−02 | −4.228190E−03 | |
| 5 | 1.818350E−01 | −7.751260E−02 | 1.783940E−02 | −1.662560E−03 | |
| 6 | −1.183150E−02 | 4.081080E−03 | −7.366170E−04 | 5.396860E−05 | |
| 7 | −4.914530E−02 | 1.688370E−02 | −3.122800E−03 | 2.400460E−04 | |
| 8 | 6.232450E−04 | −5.188580E−05 | −2.700780E−05 | 9.859750E−07 | |
| 9 | 6.106740E−04 | −9.485810E−05 | −2.397330E−05 | 2.645870E−06 | |
| 10 | 7.676150E−03 | −1.968570E−03 | 2.528130E−04 | −1.084350E−05 | |
| 11 | −7.309410E−03 | 2.637200E−03 | −4.654710E−04 | 3.183450E−05 | |
| 12 | −1.183680E−03 | 5.046330E−04 | −7.896650E−05 | 4.566380E−06 | |
| 13 | 4.070680E−05 | 9.860990E−05 | −1.654250E−05 | 8.796720E−07 | |

TABLE 17
Example 8: Aspherical Surface Data

| Surface | K | A3 | A4 | A5 | A6 |
|---|---|---|---|---|---|
| 2 | 9.178920E−01 | −7.405340E−04 | 3.662300E−03 | −1.093140E−02 | 1.770420E−02 |
| 3 | 6.469960E+00 | −1.927500E−03 | −8.155180E−03 | 7.023110E−03 | −3.061130E−02 |
| 4 | 3.961090E+00 | 3.036270E−02 | −2.507230E−01 | 6.064050E−01 | −1.001890E+00 |
| 3 | −1.827460E+01 | 3.450780E−02 | −1.724560E−01 | 3.582870E−01 | −4.932090E−01 |
| 6 | −5.191170E+00 | −7.332970E−03 | 1.104760E−02 | −4.501570E−02 | 5.856150E−02 |
| 7 | −6.750740E+02 | −1.821620E−02 | 7.100940E−02 | −1.928600E−01 | 2.226110E−01 |
| 8 | 1.697730E+01 | 7.432120E−03 | −1.410150E−02 | −1.077590E−02 | 1.892370E−03 |
| 9 | −2.309000E+01 | 6.391200E−04 | −1.244710E−02 | −5.444190E−03 | 2.499380E−03 |
| 10 | 8.938700E−01 | 1.054570E−02 | −3.201090E−02 | 3.474940E−02 | −3.307210E−02 |
| 11 | −4.567310E+00 | 1.256760E−02 | −8.038540E−03 | −6.984830E−03 | 1.634960E−02 |
| 12 | −1.119380E+01 | 2.652850E−02 | −8.470570E−02 | 4.103830E−02 | −3.949730E−03 |
| 13 | −4.985460E+00 | 2.554250E−02 | −6.256450E−02 | 3.536180E−02 | −8.399510E−03 |
| | A7 | A8 | A9 | A10 | |
| 2 | −1.536160E−02 | 6.886360E−03 | −1.190790E−03 | −1.385950E−04 | |
| 3 | 4.264080E−02 | −2.802720E−02 | 7.365060E−03 | −5.562570E−04 | |
| 4 | 9.802040E−01 | −5.487840E−01 | 1.590810E−01 | −1.790730E−02 | |
| 5 | 4.159340E−01 | −2.058950E−01 | 5.440350E−02 | −5.752330E−03 | |
| 6 | −4.253630E−02 | 1.808080E−02 | −4.202510E−03 | 4.021140E−04 | |
| 7 | −1.551010E−01 | 6.525720E−02 | −1.473130E−02 | 1.358510E−03 | |
| 8 | 2.757330E−03 | 1.102470E−04 | −2.093640E−04 | −3.074560E−05 | |
| 9 | 1.195400E−03 | −2.235560E−04 | −7.207640E−05 | 8.913950E−06 | |
| 10 | 2.765040E−02 | −5.412960E−03 | 8.325010E−04 | −3.938230E−05 | |
| 11 | −1.239410E−02 | 4.868760E−03 | −9.597580E−04 | 7.441810E−05 | |
| 12 | −2.895260E−03 | 1.388710E−03 | −2.679250E−04 | 1.968440E−05 | |
| 13 | 1.275910E−04 | 3.645340E−04 | −7.487120E−05 | 4.931000E−06 | |

TABLE 18
Example 9: Aspherical Surface Data

| Surface | | | | | |
|---|---|---|---|---|---|
| Number | K | A3 | A4 | A5 | A6 |
| 1 | 8.471840E−01 | 1.523350E−03 | −1.553290E−03 | −3.862080E−03 | 1.426540E−02 |
| 2 | 6.505710E+00 | 3.323730E−03 | −2.173440E−02 | 2.587750E−02 | −3.325870E−02 |
| 4 | 2.223250E+00 | 3.002660E−02 | −1.963080E−01 | 4.276680E−01 | −6.601780E−01 |
| 5 | −1.831450E+01 | 3.178720E−02 | −1.406610E−01 | 2.841090E−01 | −3.670830E−01 |
| 6 | −6.236890E+00 | −8.101090E−03 | 4.562210E−03 | −3.035540E−02 | 4.125820E−02 |
| 7 | −5.518420E+02 | −1.888110E−02 | 5.977580E−02 | −1.558990E−01 | 1.763660E−01 |
| 8 | 3.906130E+01 | 1.033110E−03 | −9.364730E−03 | −1.034730E−02 | 8.968540E−04 |
| 9 | −5.000000E+01 | −1.099600E−03 | −2.396950E−02 | −6.157100E−03 | 4.903190E−03 |
| 10 | 1.272420E+00 | 5.738090E−03 | −4.694090E−02 | 3.632510E−02 | −3.028600E−02 |
| 11 | −4.344430E+00 | −6.380790E−03 | −1.285620E−02 | −7.436940E−03 | 3.034700E−02 |
| 12 | −2.635970E+01 | −1.633190E−03 | −4.547480E−02 | 2.295770E−02 | −1.658130E−03 |
| 13 | −4.557090E+00 | 1.152550E−02 | −5.054020E−02 | 3.097910E−02 | −7.793620E−03 |
| | A7 | A8 | A9 | A10 | |
| 1 | −1.601060E−02 | 6.722470E−03 | 6.223870E−05 | −6.194310E−04 | |
| 2 | 2.815440E−02 | −2.002320E−02 | 9.123960E−03 | −2.076630E−03 | |
| 4 | 6.071700E−01 | −3.212290E−01 | 8.642480E−02 | −8.670060E−03 | |
| 5 | 2.919400E−01 | −1.383230E−01 | 3.507010E−02 | −3.519550E−03 | |
| 6 | −2.573230E−02 | 9.057950E−03 | −2.117290E−03 | 2.708840E−04 | |
| 7 | −1.199210E−01 | 4.838650E−02 | −1.037950E−02 | 9.098840E−04 | |
| 8 | 2.658830E−03 | 1.660260E−04 | −1.719920E−04 | −2.325930E−05 | |
| 9 | 1.155920E−03 | −4.836160E−04 | −5.308190E−05 | 1.988650E−05 | |
| 10 | 1.858270E−02 | −6.189060E−03 | 8.725000E−04 | −2.077320E−05 | |
| 11 | −2.683580E−02 | 1.169380E−02 | −2.544580E−03 | 2.159990E−04 | |
| 12 | −1.247280E−03 | 4.369390E−04 | −7.085390E−05 | 4.981660E−06 | |
| 13 | 2.162080E−04 | 3.215010E−04 | −6.875100E−05 | 4.631580E−06 | |

TABLE 19
Values Related to Conditional Formulae

| | | Example | Example | Example | Example | Example | Example | Example | Example | Example |
|---|---|---|---|---|---|---|---|---|---|---|
| | Formula | 1 | 2 | 3 | 4 | 5 | 6 | 7 | 8 | 9 |
| νd2 | (1) | 23.63 | 23.63 | 23.63 | 23.63 | 23.63 | 23.63 | 23.63 | 23.63 | 23.63 |
| νd4 | (2) | 23.63 | 23.63 | 23.63 | 23.63 | 23.63 | 23.63 | 23.63 | 55.89 | 23.63 |
| 1/f1 | (5), (6) | 0.12 | 0.13 | 0.10 | 0.12 | 0.12 | 0.13 | 0.10 | 0.12 | 0.12 |
| 1/f2 | (3) | −0.10 | −0.11 | −0.07 | −0.08 | −0.08 | −0.09 | −0.07 | −0.10 | −0.10 |
| 1/f3 | (5) | 0.11 | 0.11 | 0.09 | 0.10 | 0.10 | 0.10 | 0.08 | 0.11 | 0.08 |
| 1/f4 | (3), (4) | −0.02 | −0.02 | −0.03 | −0.03 | −0.02 | −0.03 | −0.03 | −0.01 | −0.04 |
| 1/f5 | (6) | 0.27 | 0.28 | 0.23 | 0.28 | 0.29 | 0.28 | 0.23 | 0.27 | 0.33 |
| 1/f6 | (4) | −0.34 | −0.34 | −0.27 | −0.33 | −0.33 | −0.33 | −0.26 | −0.35 | −0.35 |
| (1 − Nd2)/R5 | (8) | −0.15 | −0.15 | −0.12 | −0.14 | −0.14 | −0.14 | −0.12 | −0.15 | −0.15 |
| (1 − Nd5)/R11 | (9) | 0.23 | 0.23 | 0.20 | 0.25 | 0.25 | 0.25 | 0.20 | 0.23 | 0.29 |

What is claimed is:

1. An imaging lens substantially consisting of six lenses, including:
a first lens having a positive refractive power and a convex surface toward an object side;
a second lens having a negative refractive power;
a third lens having a positive refractive power;
a fourth lens having a negative refractive power;
a fifth lens having a positive refractive power; and
a sixth lens having a surface toward an image side which is concave in the vicinity of an optical axis and convex at the peripheral portions thereof, provided in this order from the object side;
an aperture stop being provided more toward the object side than the surface of the third lens toward the image side; and
the distance along the optical axis from the surface of the first lens toward the object side to an image formation plane being 10 mm or less.

2. An imaging lens as defined in claim 1, wherein:
the sixth lens has a negative refractive power.

3. An imaging lens as defined in claim 1, wherein:
the second lens has a concave surface toward the image side.

4. An imaging lens as defined in claim 3 that further satisfies the following conditional formula:
−1.0<(1−Nd2)/R5<0 (8)
wherein Nd2 is the refractive index of the second lens with respect to the d line, and R5 is the radius of curvature of the surface of the second lens toward the image side.

5. An imaging lens as defined in claim 4 that further satisfies the following conditional formula:
−0.3<(1−Nd2)/R5<−0.05 (8-1).

6. An imaging lens as defined in claim 1, wherein:
the fifth lens has a convex surface toward the image side.

7. An imaging lens as defined in claim 6 that further satisfies the following conditional formula:
0<(1−Nd5)/R11<1.0 (9)
wherein Nd5 is the refractive index of the fifth lens with respect to the d line, and R11 is the radius of curvature of the surface of the fifth lens toward the image side.

8. An imaging lens as defined in claim 7 that further satisfies the following conditional formula:
0.05<(1−Nd5)/R11<0.4 (9-1).

9. An imaging lens as defined in claim 1 that further satisfies the following conditional formula:
1/f2<1/f4 (3)
wherein f2 is the focal length of the second lens, and f4 is the focal length of the fourth lens.

10. An imaging lens as defined in claim 1 that further satisfies the following conditional formula:
1/f6<1/f4 (4)
wherein f6 is the focal length of the sixth lens, and f4 is the focal length of the fourth lens.

11. An imaging lens as defined in claim 1 that further satisfies the following conditional formula:
1/f3<1/f1 (5)
wherein f1 is the focal length of the first lens, and f3 is the focal length of the third lens.

12. An imaging lens as defined in claim 1 that further satisfies the following conditional formula:
1/f1<1/f5 (6)
wherein f1 is the focal length of the first lens, and f5 is the focal length of the fifth lens.

13. An imaging lens as defined in claim 1 that further satisfies the following conditional formula:
vd2<35 (1)
wherein vd2 is the Abbe's number of the second lens with respect to the d line.

14. An imaging lens as defined in claim 13 that further satisfies the following conditional formula:
vd2<30 (1-1).

15. An imaging lens as defined in claim 1 that further satisfies the following conditional formula:
vd4<35 (2)
wherein vd4 is the Abbe's number of the fourth lens with respect to the d line.

16. An imaging lens as defined in claim 15 that further satisfies the following conditional formula:
vd4<30 (2-1).

17. An imaging lens as defined in claim 1, wherein:
the aperture stop is provided more toward the object side than the surface of the first lens toward the image side.

18. An imaging apparatus equipped with an imaging lens as defined in claim 1.
